(19) United States
(12) Patent Application Publication
(10) Pub. No.: US 2010/0211968 A1
(43) Pub. Date: Aug. 19, 2010

(54) Networked digital media review and play system

(75) Inventors: Boris Itskov, Concord (CA); Valery Levitan, Condord (CA); Peter Guterres, Concord (CA); Serge Bourenkov, Concord (CA)

Correspondence Address: DENNISON ASSOCIATES, 133 RICHMOND STREET WEST, SUITE 301, TORONTO, ON, M5H 2L7, CA

(73) Assignee: JVL CORPORATION, Concord (CA)

(21) Appl. No.: 12/453,011

(22) Filed: Apr. 27, 2009

(30) Foreign Application Priority Data
Apr. 25, 2008 (CA) 2629900

(51) Int. Cl. H04N 7/16; H04N 7/18

(52) U.S. Cl. 725/25; 725/82

(57) ABSTRACT

A system for the play of digital content in a public establishment includes a digital content play system, a web accessible digital content server, a media center connected to the digital content play system and in communication with the digital content server to receive digital content, and independent web enabled or text messaging enabled devices of users. These independent web enabled or text messaging enabled devices allow a user to access the digital content server and select digital content for play on the in-house digital content play system.

### FIELD OF THE INVENTION

The present invention relates to a method and system for play authorized of multimedia content in a public establishment.

### BACKGROUND OF THE INVENTION

It is common in public establishments to have an in-house audio/video system play music and/or video recordings in accordance with the particular decisions of the owner or on a client selected basis such as would be common with jukeboxes. It is also known to have game terminals suitable for more selected viewing of video content and/or the playing of video games. Various arrangements for the appropriate payment of copyright or performance fees are prearranged by the owner based on contents of the database. Typically, the database is onsite.

The ability to store a host of audio or video files on personal portable devices has allowed users to easily transport their music or video files for selective personal play at diverse locations or activities. Due to the low cost capability to store digital content, the selected music and/or video may vary widely. It is also now quite cost effective to store a large number of video or audio files suitable for play on a public system. These personal and commercial systems may also provide summary information, ID tags, allowing music and/or videos to be easily identified, categorized and sorted.

For certain applications, it would be desirable as a customer or user, to have certain personal audio and/or video files available for play in a public establishment. For example, if a large group is meeting at a particular restaurant or establishment, it would be desirable to schedule both the audio and video content that will be played at that point in time using the in-house system and/or selected devices within the public establishment. Furthermore, it would be desirable from the establishment's point of view that this function be carried out in an automated or semi-automated manner as determined by the owner. In such an automated system it would be desirable to include the ability to pay for the playing of particular audio and video content including any licensing or performance fees as may be legally required. It would also be desirable to specify particular devices within the establishment for selective play of the audio and video content.

Various arrangements are disclosed in the present application for carrying out these functions and variations thereof.

### SUMMARY OF THE INVENTION

A system for play of a digital content in a public establishment according to the present invention comprises a digital content play system, a media center connected to the digital content play system and in communication with a remote accessible digital content server to receive digital content. The remote accessible digital content server includes a communication function for receiving communications authorizing digital content for play on the digital content play system. Independent users using their own devices can access the digital content server using the communication function to order digital content for play on the digital content play system. The remote accessible digital content server communicates with the digital content play system and at least authorizes play of ordered digital content. The media center provides to the digital content play system the ordered digital content for play thereof on the digital content play system.

In an aspect of the invention, the communication function includes SMS communications and at least some of the independent text enabled devices communicate with said digital content server using SMS messaging.

In an aspect of the invention the communication function allows web access to the digital content server using web enabled devices of users.

In a further aspect of the invention, the media center receives and provides the digital content as streamed digital content to the digital content play system.

In a different aspect of the invention, the system includes terminal devices located in the public establishment and in communication with the digital content server. The terminal devices include software allowing users to select digital content for play on the digital content play system and the terminal devices communicate the selections to the digital content server. The digital content server thereafter provides the digital content to the media center preferably as streamed digital content.

In a preferred aspect of the invention, the system includes menus of listed digital content available for play in the commercial establishment with the menus being available in the commercial establishments. Preferably, the menus are printed and made available to patrons of the public establishment.

According to an aspect of the invention, digital content for play can be ordered by using SMS text messaging or placing an order with an order staff assigned to patron by the commercial establishment.

In a preferred aspect of the invention, the menus include codes assigned to uniquely identify digital content for play. Preferably these codes also identify the commercial establishment.

### BRIEF DESCRIPTION OF THE DRAWINGS

Preferred embodiments of the invention are shown in the drawings, wherein:

FIG. 1 is a schematic overview of the system;

FIG. 2 is a schematic of an alternate system;

FIG. 3 is a schematic of the equipment in the commercial establishment of the alternate system;

FIG. 4 is a schematic of the Digital Content Management System and Licensing Authorities of the alternate system;

FIG. 5 is a schematic showing further details of the Music on Demand Provider and the Content Provider illustrated in the alternate system of FIG. 2;

FIG. 6 is a schematic showing details of the media center used to act as a control arrangement;

FIGS. 7 and 8 are schematics of alternate arrangements;

FIGS. 9 through 14 show a series of user access menus for inputting instructions to the system; and

FIGS. 15 and 16 show variations of the systems;

FIG. 17 is a schematic overview of a modified game and jukebox system;

FIG. 18 is a schematic overview of a simplified game and music system;

FIG. 19 is a schematic of a system where selections can be ordered using text messaging sent by an end user's device or a simplified provided device to a remote server having text messaging communication capabilities;

FIG. 20 is a screen shot of an initial screen presented to a user contacting the iTouch music website for ordering a digital record for play at a desired location;

FIG. 21 is a partial screen used for the user to identify the particular location at which he wishes a particular digital record to be played;

FIG. 22 is a screen shot showing various types of selections available at a particular selected location;

FIG. 23 is a further screen shot where the user has selected the category “dance”;

FIG. 24 is a screen shot showing a particular selection made by the user;

FIG. 25 is a screen shot showing confirmation that an order has been placed;

FIG. 26 is a schematic of an alternate arrangement;

FIGS. 27 through 30 are different screen shots illustrating music selection; and

FIG. 31 is a screen shot of a web enabled search screen for music selection.

### DETAILED DESCRIPTION OF THE PREFERRED EMBODIMENTS

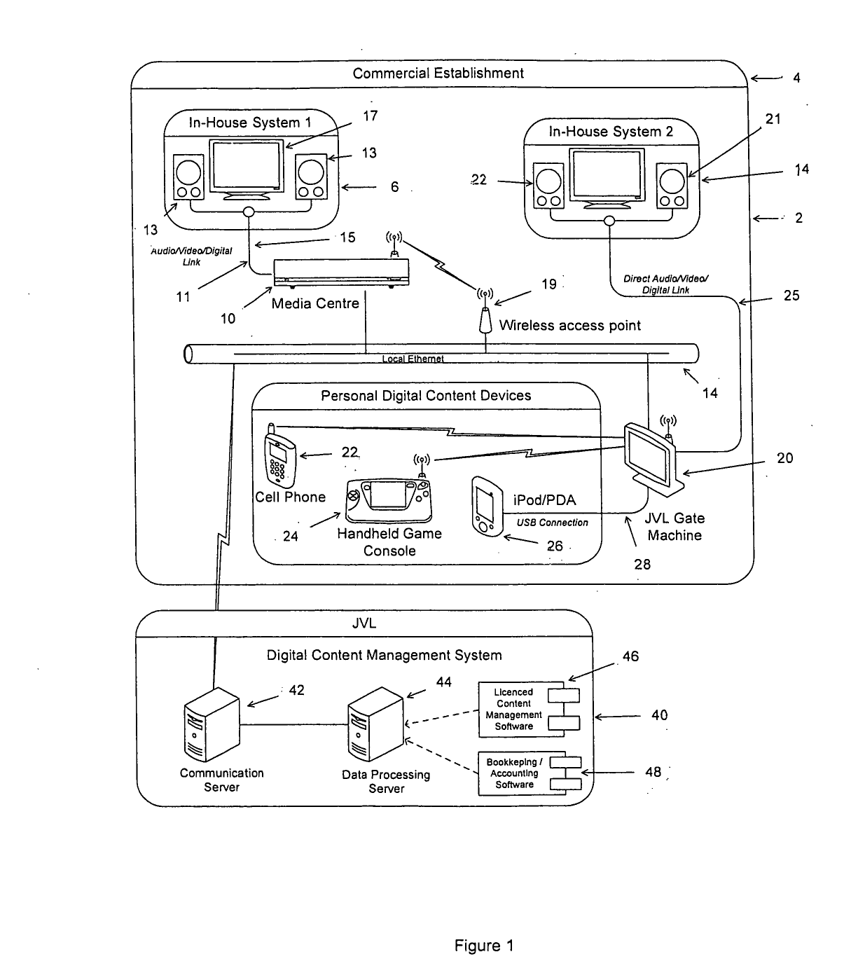

The media play system 2 shown in FIG. 1 is for use in a commercial or public establishment generally indicated as 4. Such commercial establishments include restaurants, night clubs and other public entertainment facilities or businesses. The performance or play of digital content, subject to copyright protection, (audio video, game contents, etc.) in public establishments requires appropriate authorization.

Shown within the commercial establishment is a first in-house system 6 and a second in-house system 8. The in-house systems 6 and 8, each typically include an amplifier 9 for receiving a signal from one or more source devices such as a CD player, hard drive, receiver etc. The signal is appropriately processed and provided to the speakers 13. This type of device can also control the video source signal. The media center 10 provides a communication and control switch function for integrating control gate 20 into existing systems.

Preferably, the various sources of multi-media content are connected to the media center 10 and the media center 10 provides the appropriate signal to one or more of the in-house systems 6 and 8. The control gate 20 can interrupt signals from other sources to the amplifier and essentially override other sources as may be required. In this way, the control gate and media center provide a switch function for controlling the content on the in-house systems.

Advantageously, the control gate and media center 10 cooperate with existing audio/video systems.

The first in-house system 6 includes an audio link 11 connecting a pair of speakers 13 to the media center 10. A video link 15 connects the media center 10 to a display screen 17. The media center 10 includes a connection 12 to the local Ethernet network 14 and is typically in communication with the digital management system 40 over the INTERNET. The digital management system can store and provide audio and video content to the in-house system 6 in a somewhat conventional manner as the content and licensing provisions have been established, allowing the digital management system to provide or authorize the specific use of the digital content. Preferably, the digital management system is remotely located but this system could be located on site. The local Ethernet network can include a wireless transmission and receive capability 19 for communication with other related components, including an INTERNET connection with the remotely located server 42 of the digital management system.

The second in-house system 8 includes a pair of speakers 21, a display screen 23 and signal processing arrangement, and a direct digital link 25 connecting these components to the control gate 20. This embodiment also includes the control of signals to the in-house system 8. This arrangement may be appropriate for less sophisticated applications or systems as a separate media center 10 is not used.

The control gate 20 allows effective communication with any of a series of personal digital content devices such as the cell phone 22, the handheld game console 24, and/or the IPod/PDA 26. These personal digital content devices are owned by a customer and are capable of communicating in a wireless communication with the control gate 20. In addition, there can be a hard wire connection such as a USB connection 28 connecting a video player and/or IPod/PDA 26 with the control gate 20. Any of the personal digital content devices can include a suitable arrangement for effective communication with the control gate 20 including (as examples) a digital connection such as WiFi, infrared, GPRS, 3G, Bluetooth, HDMI and Optical Link, or by an analog link. These personal digital content devices are controlled by the user and digital files contained therein or identification information of the particular files can be effectively communicated to the control gate 20 for eventual play on the in-house system 8. The actual digital content can be provided from different sources in communication with the control gate.

The control gate 20 provides a coordinating function used to identify the content about to be played on the in-house system 8. This content or summary identification information can be communicated to the communication server 42 over the local Ethernet network 14 and reviewed by the digital processing server 44. In this way, the content about to be played on the in-house system 8 can be audited to provide the appropriate tracking of digital media content played in the commercial establishment. For example, if the audio content includes a series of songs, these songs can be identified and appropriately authorized for play on the in-house system 8. This authorization can also be used with respect to video content. The actual files or media content played may be provided by a local or remote database.

In some cases, the material being forwarded by one of the personal digital content devices will not be subject to copyright provisions, as the owner is unknown, or perhaps the user is already the owner. Therefore there may be some material that can be used with the in-house system 8 without authorization from the digital content Management System. For example, a certain office group may plan a marketing or sales meeting and wish to display this audio/video content for review in a more informal session. As the copyright owner is effectively the owner of the personal digital content, no further compensation would be required.

In contrast, particularly for audio content, the material may be music and this music or summary identification information may be reviewed to determine whether authorization is required. As technology advances, the music content can be analyzed to compare it to a host of known digital content for appropriate identification and any required authorization.

The control gate 20 includes the direct audio/video/digital link 25 to the in-house system 8. With this system, the customer who owns one of the personal digital content devices 22, 24, and 26, for example, has loaded these devices with music, video games, digital pictures, multimedia files, etc. that they wish to play on the in-house system 8. A suitable connection is made with the control gate 20 that typically includes a touch screen and software for effective communication with these devices. The information is then provided to the in-house system 8. The digital management system 40 reviews digital content or ID information communicated thereto by the control gate and the data processing server 44 reviews and tracks the digital content for reporting to the appropriate Content Providers.

With this system, users of portable devices can have the content stored internally or can have access to an external source, for example, a satellite radio receiver or a source of streaming audio and/or video content. The important aspect is that the customer is in control of identifying the digital content. The control gate 20 is connected to the in-house multimedia system at the commercial establishment and transmits the user's selection to the system. The control gate 20 is connected to a digital control management system that verifies the content and tracks copyright payment information. This digital control management system process is typically carried out remotely of the commercial establishment. The control gate allows play of the selection through the above mentioned audio or video connection. The control gate 20 is preferably part of other systems that include a payment facility such as a video game terminal and/or a digital jukebox. As can be appreciated, this particular ability to allow the user to provide or identify the audio or video content, can advantageously supplement existing digital or video systems.

The control gate 20 provides the ability to select audio/video files to be played and/or the personal digital content device allows the user to select the files. The system is capable functioning in both of these manners. As the capability of personal digital content devices continues to expand, their use as an input device to select files will also expand.

With this arrangement, the control gate 20 coordinates examination of the content to be played by the customer and appropriately classifies this information in combination with the digital content management system 40. The digital content management system 40 provides the results of the review of the content to the control gate and the appropriate authorization for this play of the selected digital content. This content can also include real time streaming of audio and/or video content to the control gate.

The digital content management system 40 includes a bookkeeping function to record and process all the payment information and content identifying information including the digital content title (ID), number of times played, and/or the duration of each, and the total play time, depending on the content. This also provides copyright control and monitoring. For example, the control gate 20 can be set to operate and prohibit playing music that is not recognized by the digital content management system. In other cases, there may be certain owner or manual override provisions that allow the playing of music which is not recognized. In this way, unrecognized content can be prohibited or subject to authorized override. The digital content management system also provides effective accounting control and based thereon, provides reports for submission to the various copyright owners, label companies, software manufacturers, etc.

For the purpose of clarity and to better understand the operation of the system, the various components and functions have been separated. In implementing the system, these components may be combined. For example, the control gate may be part of the in-house system or integrated with the digital content management system or integrated with both of these functions. For example, the control gate could be a combination game/jukebox/input terminal available to customers. It could also be a modified jukebox having this terminal user file identification transfer/interaction capability.

There are also other arrangements for accessing audio/video files available for play in a public establishment and these arrangements can be used with the control gate function disclosed in the present application. Accessing authorized databases remotely located or onsite, provides a system that is less vulnerable to unauthorized play of material protected by copyright provisions while still satisfying or expanding the authorized play of material.

It is also possible to have the personal digital content devices include a separate function for interacting with public audio/video systems. These separate functions could be provided with the device or downloaded thereto. For example, known Music on Demand systems could be used with the present system to provide the appropriate authorization capability.

The digital content management system is authorized and tracks, and/or the play of the digital content. It is also possible for the control gate 20 to allow a user to communicate with an independent provider such as a Music on Demand provider. For example, a user can use the control gate 20 to access his account with the Music on Demand provider. This account can include a list of favourite music to simplify the selecting process for the user. The user can select the desired content and this content and/or identification information can be provided to the control gate. This content is preferably tracked as previously outlined by the digital content management system. It is also possible for authorization to be provided by the Music on Demand provider. For example, communication by the user using the control gate identifies this request as associated with use in a public establishment. The content could be streamed to the gate or transferred and temporarily stored, if authorized. Basically, the independent provider can be authorized from a copyright holder or group for authorizing this performance. Tracking can be provided by the control gate and/or the digital content management system regarding payments to the independent provider.

The present invention also includes the authorization of personal digital content devices for play of audio/video files on public audio/video systems by providing software to control this function.

The above system has been described primarily with respect to music and video content, however, it is also applicable to games and other forms of copyright material.

Although the digital content management system 40 can provide information feedback to the control gate 20 regarding the fee for playing of the copywritten material, this fee is preferably included in the cost per play charged by the control gate 20. With this arrangement, the digital content management system has authorized license provisions with the copyright owners or group providers.

The present invention and system provides an effective approach for the operator while allowing existing in-house audio and video systems to be used in a different manner and provide an additional income stream. Furthermore, it allows the operator to customize this in-house system for small group presentations. As can be appreciated, this could be suitable for business group lunches, etc.

As can be appreciated, the digital content management system will serve a large number of control gates at many commercial establishments.

There are many variations of this arrangement including the ability for the personal digital content devices merely to provide a list of the appropriate content to be played. IPod devices record the digital content in a manner easily used by the system. This list could have been derived from a pre-approved list available from the establishment or from the digital content system 40. For example, the material that is available for play could be provided on a website, etc., and the user could effectively pre-plan the particular material to be played.

The present system allows customers the capability of having their devices communicate with the audio/video system of a public establishment, in a convenient and effective manner. In a preferred embodiment, these devices provide identification tags that are used to identify the digital content to be played from an appropriate source, such as an authorized database of the audio/video system of the public establishment or a remote associated or independent database available to the audio/video system.

The above approach, where the personal digital content devices provide identification information of digital content to be played and the audio/video system matches the identification information with digital content authorized for play on a public system, is a preferred arrangement that reduces legal issues regarding transmission of files. The files of the personal devices, not normally authorized for public play, are not played on the audio/video system as only the identification information is used to determine the files and making the files available from an authorized source.

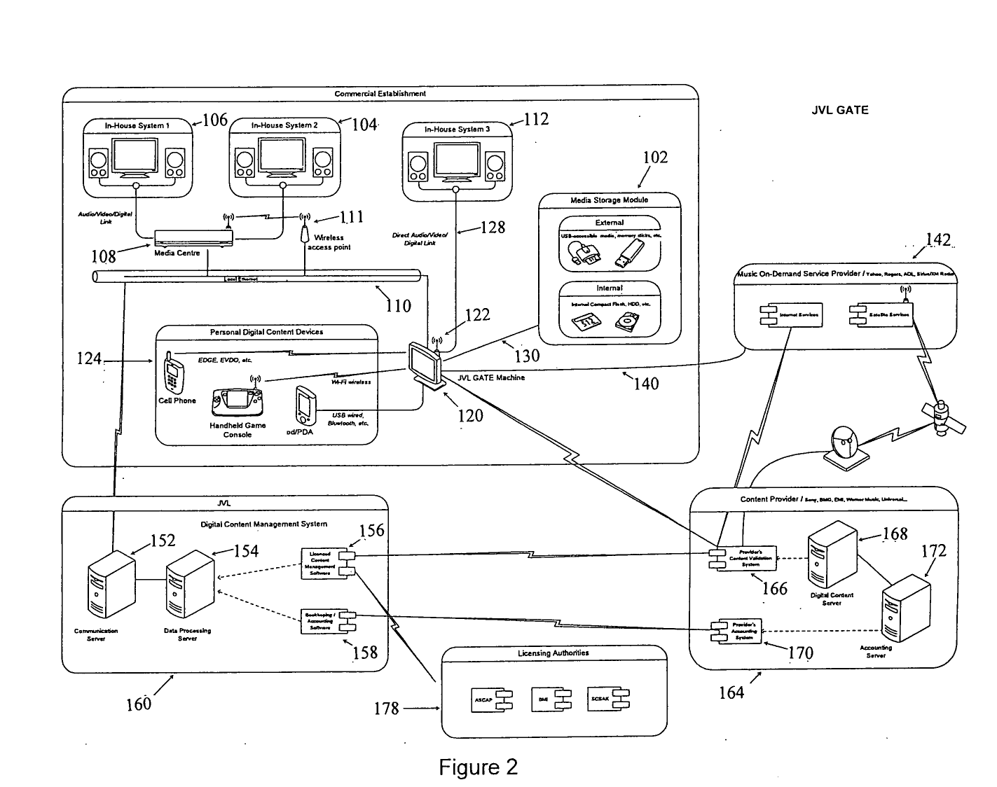

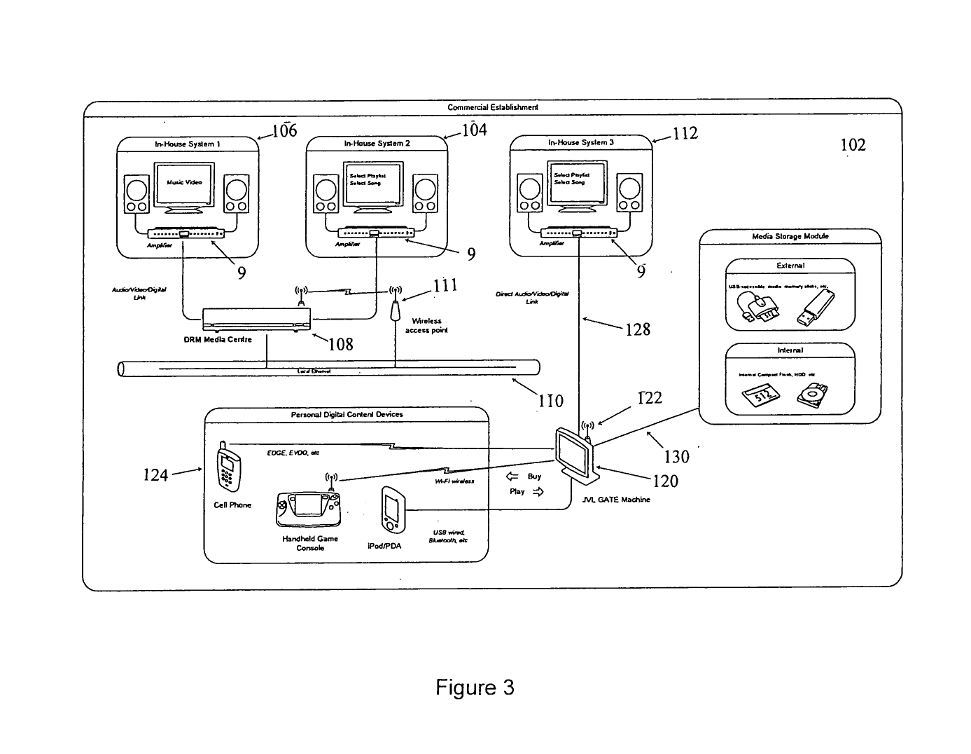

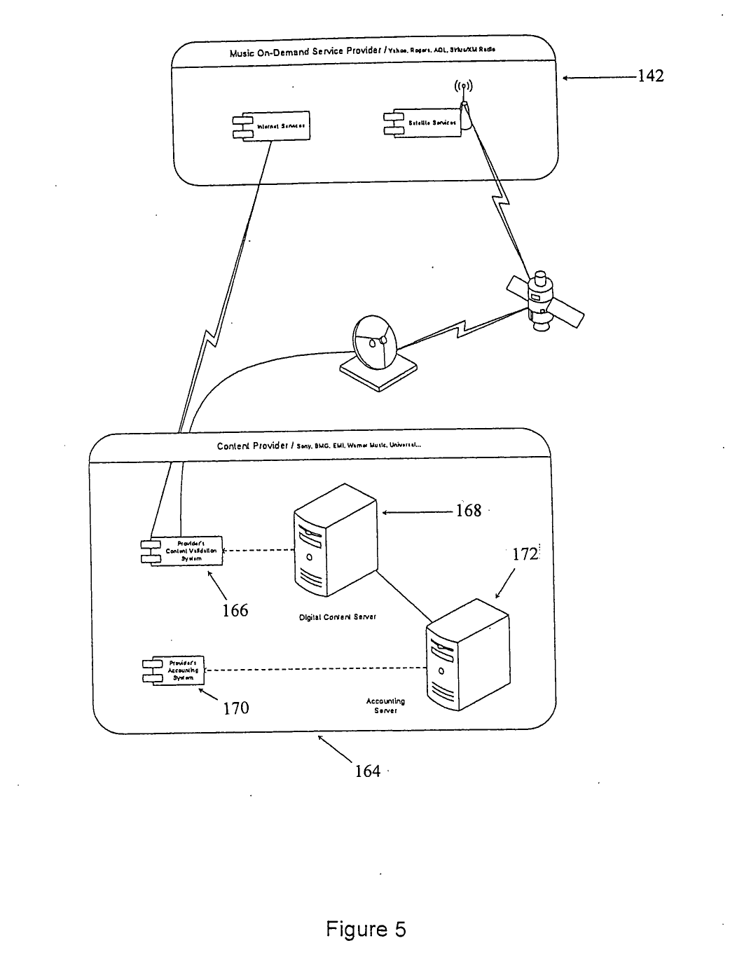

An alternate arrangement is shown in FIGS. 2 through 6. The networked entertainment performing system 100 shown in FIG. 2 is a networked system that is particularly suitable for commercial establishments such as restaurants and bars. A commercial establishment is generally shown as 102 and includes in-house audio/video systems 104 and 106 connected to the media center 108 which in turn is connected to a local area network such as a local ETHERNET connection to other computer devices within the commercial establishment. In-house system 112 is directly connected to the gate machine 120. This gate machine is physically connected to the local area network 110 and can also include a wireless communication function generally indicated as 122. Similarly, the local area network 110 includes its own wireless connection point indicated as 111. The gate machine 120 includes a physical or wireless connection to any of a number of personal digital content devices generally indicated as 124. For example, the gate machine 120 can communicate with cell phones, handheld game consoles, IPod or PDA type devices. These devices can be connected in a wireless manner or use a USB type connection.

Similarly, the gate machine 120 includes a connection 130 for communicating with known portable memory devices such as memory sticks, internal compact flash memory, portable hard disk devices or other suitable digital memory devices. In this way, the user can bring one of these devices to the commercial establishment and connect with the gate machine or one of the many gate machines provided in the commercial establishment for accessing and using the system in a specialized manner using digital content stored on these user devices.

The overall system includes Music on Demand Service Providers indicated as 142. It is now becoming more common for individual users to enter into a contract with a Music On Demand Provider indicated as 142 for the downloading and playing of music. This capability when used in association with the overall system allows a user to inform the gate machine 120 of a desire to play a particular song authorized by its Music On Demand Service Provider 142. As previously outlined, the gate machine could receive properly authorized digital content from the provider 142. The digital content, can be transferred as streaming video or audio, and forwarded to the in-house system 112 for the performance thereof. In this way, the digital content is not maintained by the system but is merely performed by the system. The authorization for this can be associated with the digital content management system or the Music on Demand Provider. The user will preferably pay the gate machine.

Many different payment arrangements and arrangements for appropriate authorization are possible.

The networked entertainment performing system preferably differs from earlier systems in that the actual digital content is not stored and subsequently performed. The digital content is streamed in real time and played on the particular system. This arrangement for many applications significantly reduces the legal issues associated with the various different content providers.

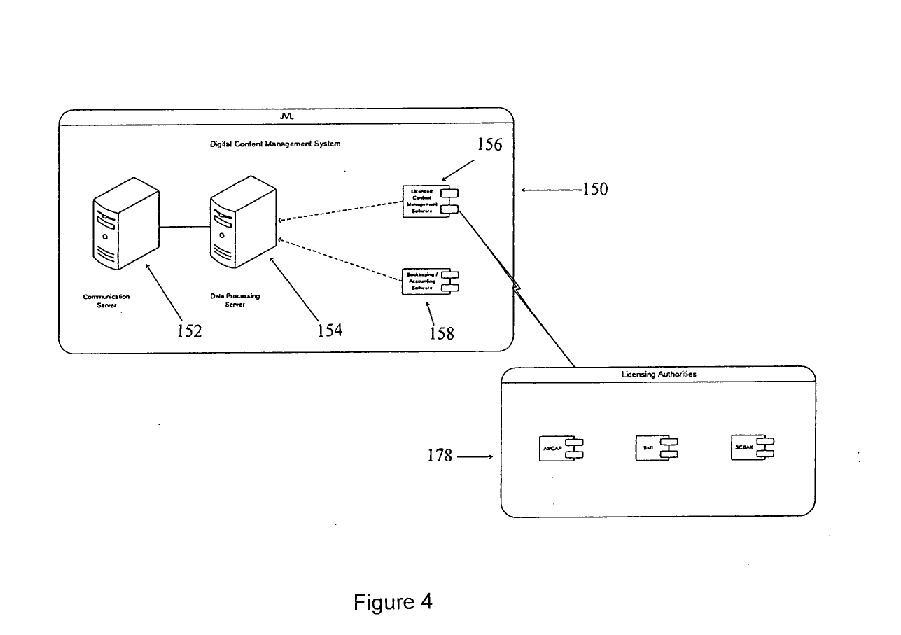

The remotely located digital content management system 150 as shown in FIGS. 2 and 4 includes a communication server 152 as well as a data processing server computer 154. Basically, the communication server 152 communicates with various control gates through the local area network 110, and preferably the INTERNET. The data processing server 154 can include license content management software for tracking of the various performing rights. Similarly, the data processing server 154 will include bookkeeping/accounting software for tracking of payments owed to the various providers. The Content Provider 164 communicates directly with the gate machine 120 and additionally communicates with the data processing server 154. The streamed audio/video signal is provided to the gate machine 120, and information with respect to the particular digital content is provided to the license content management software of the data processing server. Furthermore, the data processing server and the Content Provider 164 are also in communication between the particular accounting systems.

The content provider includes its own accounting system 170 and also includes a Content Validation System indicated as 166. The validation system is part of the Digital Content Server 168 and this is in communication with an Accounting Server shown as 172 and the Provider's Accounting Software indicated as 170. Basically, the Content Provider 164 provides the real time stream signal to the gate machine 120 and also provides a tracking arrangement recorded by the provider's Content Validation System 166, and the Licensed Content management System 156 of the Data processing server 154. The Bookkeeping/Accounting Software of the Data processing server 154 is shown as 158.

The Content Provider 164 is shown with a number of particular parties such as MusicNET* Sony*, BMG*, EMI*, Warner Music*, and Universal*, for authorizing particular digital content. Other digital content may be authorized by the Licensing Authorities indicated as 178 which can include a number of different sources. Once again, the licensing authorities communicate with the License Content Management Software 156 of the of the Data processing server 154. Preferably, these systems provide the content or authorization for play.

Preferably, this particular system provides a networked arrangement for accommodating a host of sources for providing digital content to commercial establishments without the commercial establishment storing the content. The actual commercial establishment has equipment that typically receives the signal and reproduces or performs the particular work without the separate storing thereof. This significantly reduces the legal requirements in dealing with diverse content providers and their particular rights and control of content.

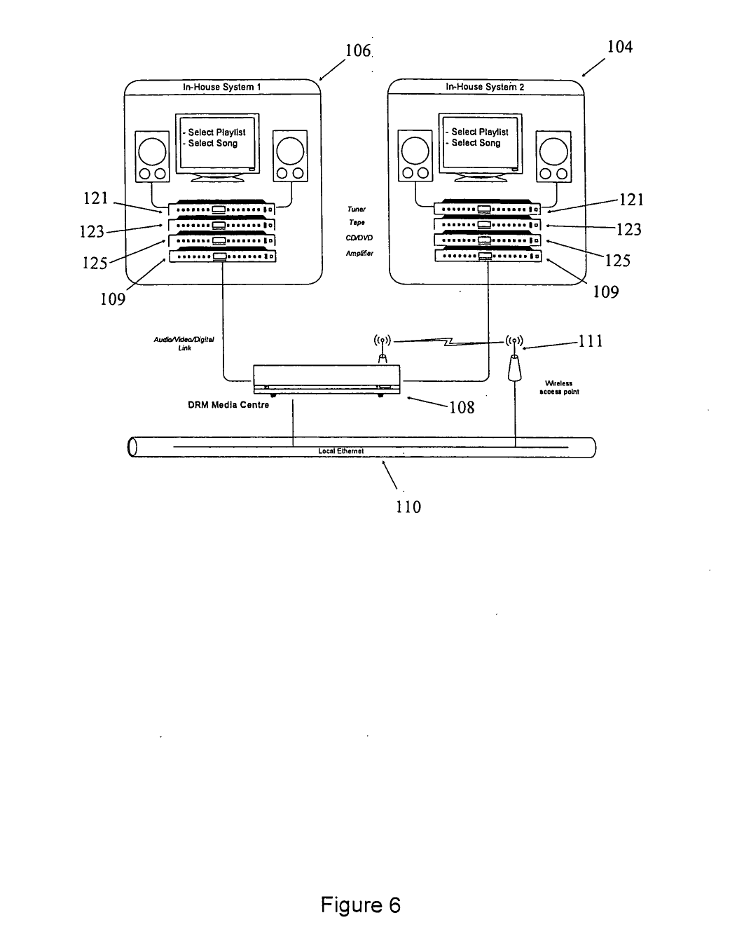

Additional details of the in-house systems 104 and 106 are shown in FIG. 6. The media center 108 cooperates with amplifiers 109 to be able to override other sources of digital content provided to the amplifiers. These other sources are conventional sources for in-house systems such as a tuner 121, a tape unit 123 and/or a CD/DVD device 125. The control gate 120 and the media center 108 allow automatic overriding of other signals.

Furthermore, a user may have his own work to be performed on the commercial system. This particular source is also accommodated by the system and the system can include particular checks to ensure that the work being performed is not subject to the rights of one of the other providers. With this system, it is in the interest of the actual commercial providers, such as the Music On Demand Provider 142, the Content Provider shown as 164, and the Licensing Authorities shown as 178, to provide the system at the commercial establishment, with information that allows identification and tracking of particular digital content. In this way, the system allows tracking of authorized users by their particular content provider. If during the performance of the work, the system recognizes the work as one requiring a different authorization, the performance may be terminated. As the system effectively charges the user a fee for the play of digital content, recognition of digital content provided by a user and incorrectly identified as not requiring further authorization, can be discouraged by forfeiture of payments already made.

Furthermore, the present system encourages the play of digital content properly authorized and tracked by the system and discourages unauthorized reproduction and performance.

With further advances in digital rights management, it will be possible to monitor, sample and/or provide summary information of digital content indicated as not requiring copyright compensation. Such information can be used to discourage unauthorized use by requiring further payments, forfeiture of existing payments and/or cancellation of privileges, if such content is recognized as requiring authorization.

The system can also be used to require material provided by a user to be subject to content review and approval prior to performance. This approval can include sampling tests or content control analyzed by the system or operator override for digital content indicated as not requiring authorization.

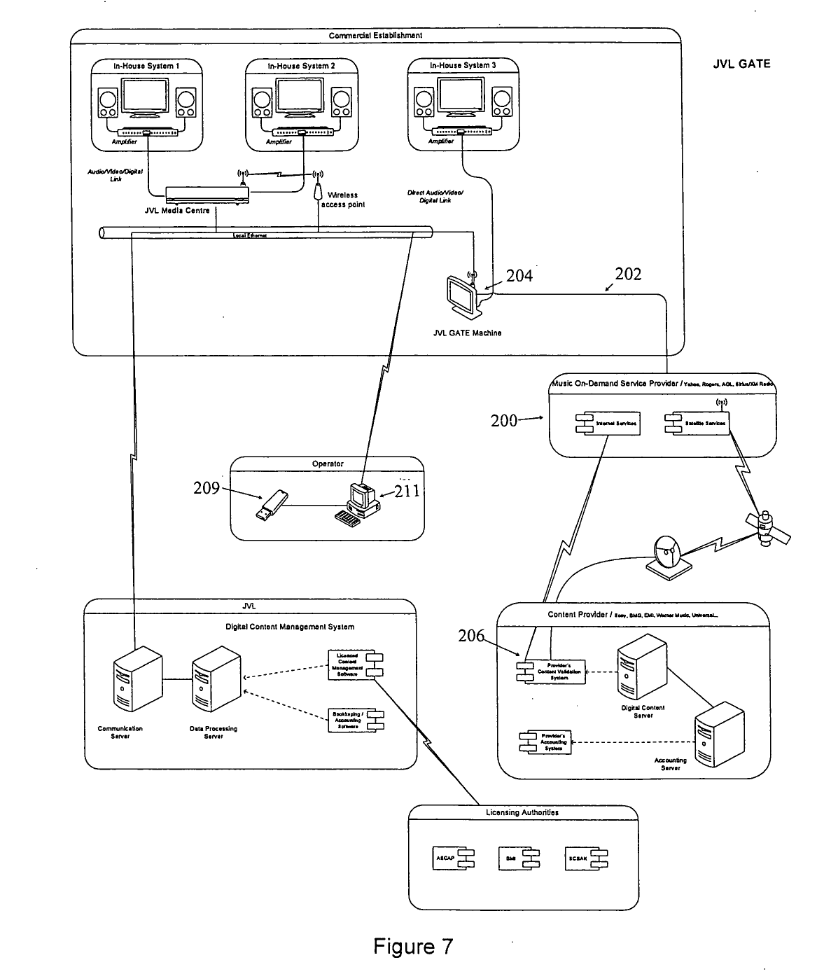

In FIG. 7, an alternate arrangement as shown that operates in a manner similar to the other embodiments. In this case, the Music On Demand Service Provider 200 includes link 202 to the gate machine 204. A user interacts with the gate machine 204 and selects different digital media content from the Music On Demand Service Provider 200. The provider 200 includes different connections with the content provider 206. The digital content is streamed to the gate machine 204 for play on any of the various in-house systems.

A further feature for providing digital content to the gate machine 204 or for use by the media center uses a portable memory device indicated as 209. The operator of the commercial establishment uses a different computer 211 to access the Content Provider 206. Digital content is downloaded to the portable memory device 209. The Operator then provides this digital content to the gate machine 204. This arrangement is useful where the real time streaming of digital content to the gate machine is not practical or reliable. Various safeguards can be provided, such as coding and/or time limited, or authorization requirement to protect unauthorized use of the digital content.

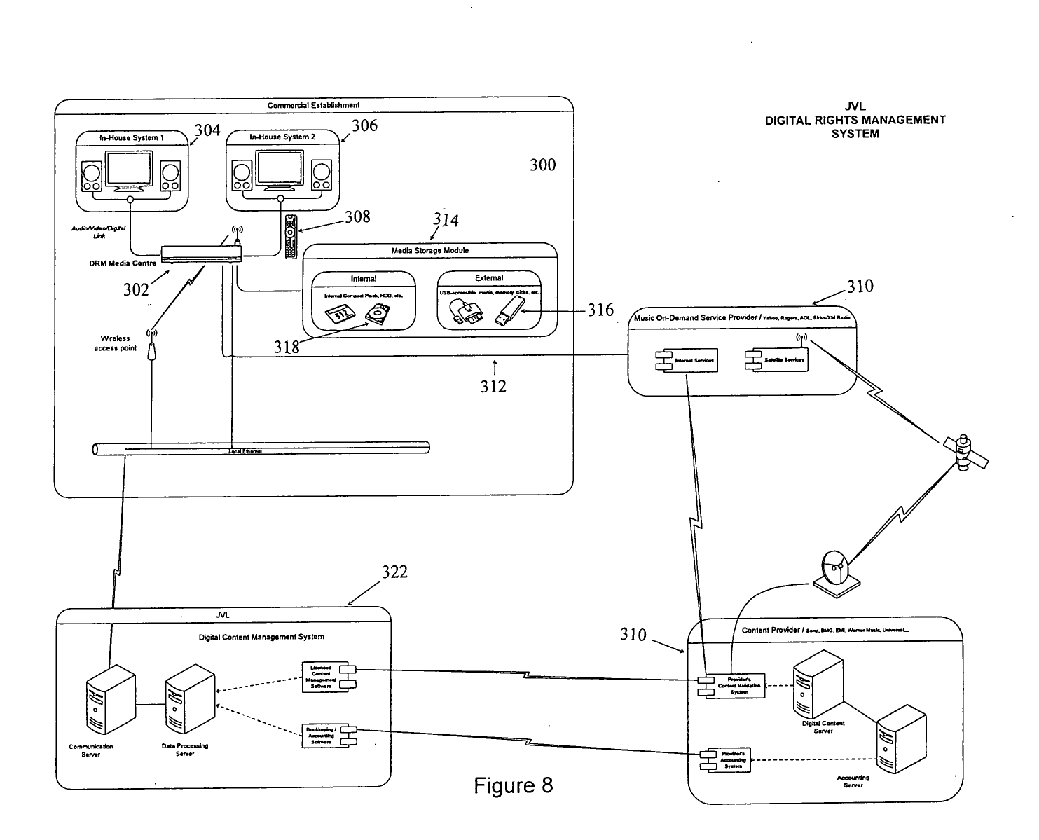

A further modification of the system is shown in FIG. 8. The system 300 for the public establishment includes the Digital Rights Management System 302 that allows effective communication with either of the in-house systems 304 or 306. A remote control device 308 allows the user to use the in-house systems, and in particular, the video screens thereof, as an effective input device. Basically, the remote control allows the user to access various menus and input the desired controls. With this arrangement, the Digital Rights Management Media Center 302 allows the in-house system to perform a number of the functions of the gate machine identified in the early systems.

The Music On Demand Service Provider 310 now includes a communication link 312 with the Digital Rights Management Media Center 302. The media center 302 also controls and is connected to the media storage module 314 that allows for recording of different digital content on different types of devices. For example, these could be user accessible media memory devices, generally indicated as 316, or internal memory devices such as compact flash hard drives etc. generally shown as 318. A user can request that the Music On Demand Service Provider 310 authorize the sale of a particular music selection or video selection and transfer to his portable memory device 316 or an internal of a particular device. With this option, a user is not only able to authorize the play of digital content, he is also able to purchase digital content and store the same on removable memory devices or internal memory devices. The particular costs and eventual accounting with the Music On Demand Service Provider and/or the content provider 320 is made through the Digital Content Management System identified as 322. The charge to the user is made by the control gate.

A further variation of this system is the possibility for the gate machine to cooperate with an operator controlled memory stick or other memory device. For example, the gate machine does not have good communication with the Digital Content Management System. It is possible for an operator to use a home computer or other system that does have good communication to download certain digital content or digital files to the portable memory device. These would be downloaded and would be specific for use in association with the Digital Rights Management System shown in the drawings.

The gate machine would then have access to this digital content for play on the system. It would track the use of the digital content and provide batch-type reporting to the Digital Content Management System and eventual communication to the content provider with the appropriate payments, etc. This digital content can be effectively managed by the content provider by providing necessary time limits where the digital content is accessible and/or particular codes necessary for further accessing of the files. Such passwords and other control parameters can be provided as the system contacts the Digital Contact Management System on a predetermined basis.

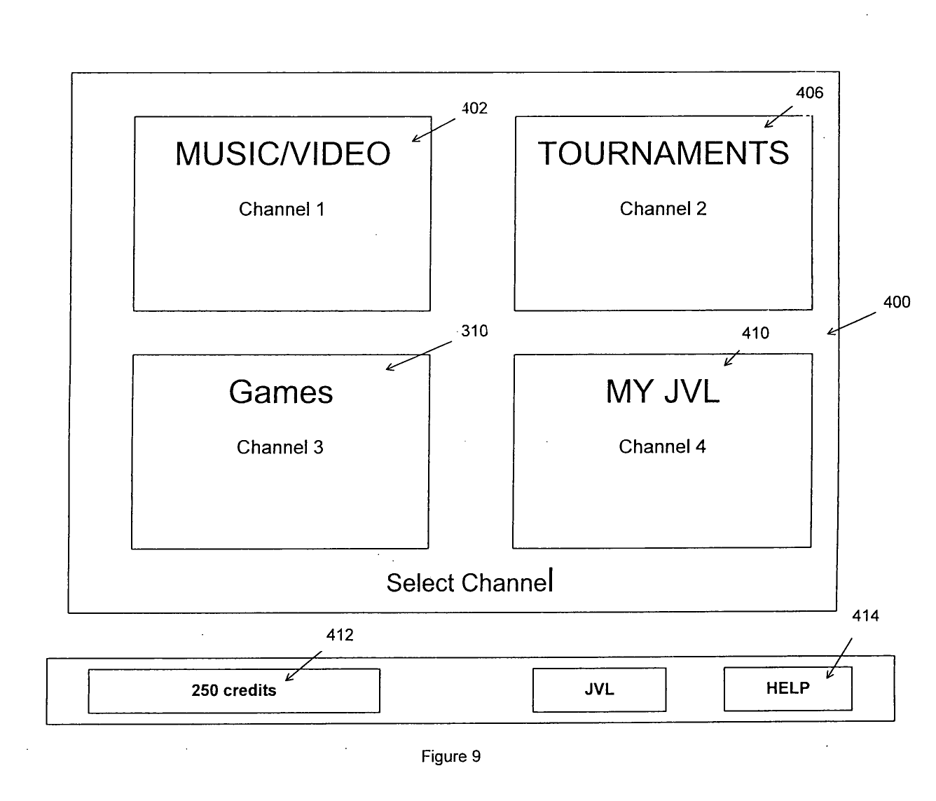

FIGS. 9 through 14 are a series of schematic screen shots presented to a user accessing the control gate or using the remote control of the system 300 shown in FIG. 8. Screen shot 400 includes four options, namely a music/video option 402, a tournament option 406, a game option 408, or a personalized option shown as 410. In addition, the screen shows the credits currently available to the user indicated as 412. A Help button is indicated as 414.

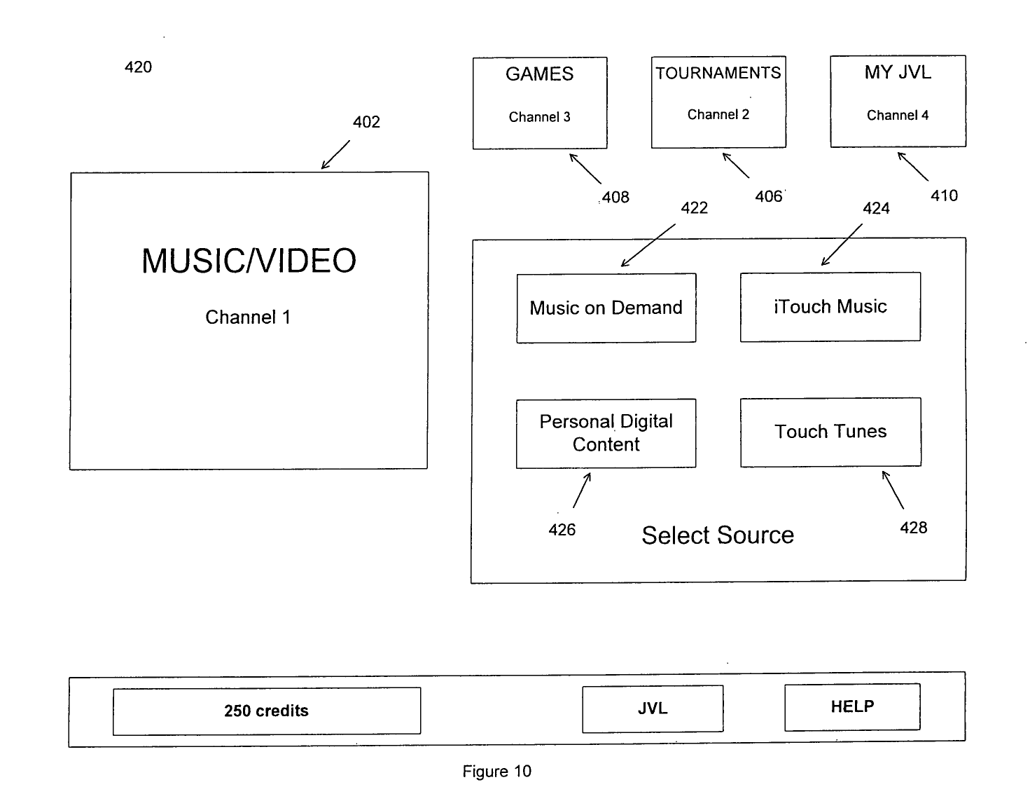

FIG. 10 is presented to the user when he has selected the music/video option indicated as 402. The screen shot 420 provides the user with the ability to go to the game option 408 or the game tournament option 406, or the personal option indicated as 410.

In FIG. 10, the user is now able to access music on demand indicated as 422, iTouch Music indicated as 424, personal digital content 426, or Touch Tunes indicated as 428. These are all particular sources of digital media content.

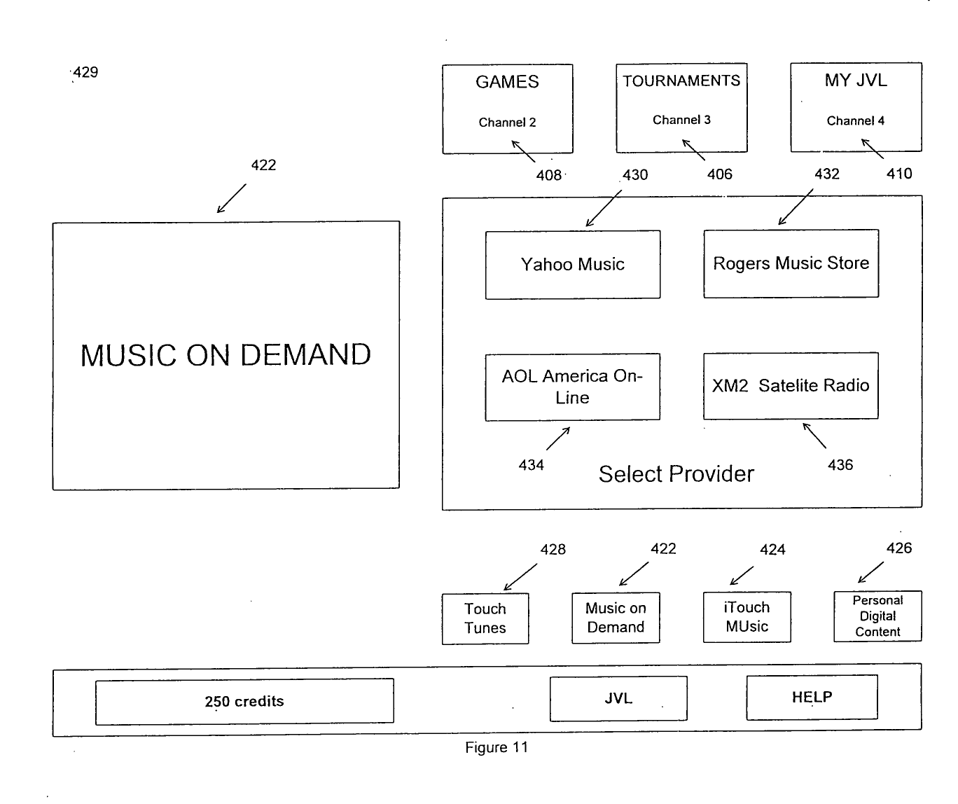

In FIG. 11, the user has activated the music on demand option 422 and is now presented with different sources of music on demand, such a Yahoo! Music 430, MusicNET, Rogers Music Store 432, AOL On-Line indicated as 434 or XM2 Satellite Radio indicated as 436. In this screen 429 of

FIG. 11, the user can return to the options of FIG. 9 by actuating any of the options 406, 408 or 410, or can return to the screen of FIG. 10 by using the various controls provided as 422, 424, 426 and 428.

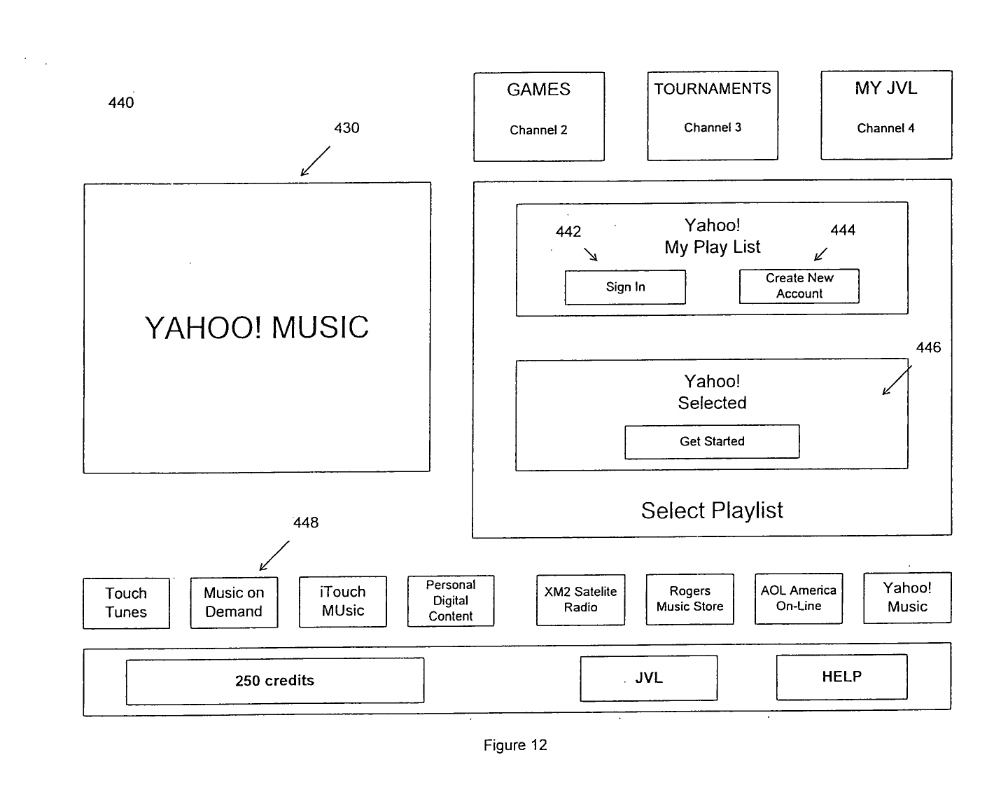

The screen shot 440 of FIG. 12 is presented when the user has selected Yahoo! Music 430. The user is presented with a sign in option 442 or create a new account option 444. This Sign In option allows the user access to his playlist. Option 446 allows the user to access various listings within Yahoo! Earlier options presented to the user are also provided as generally indicated at 448.

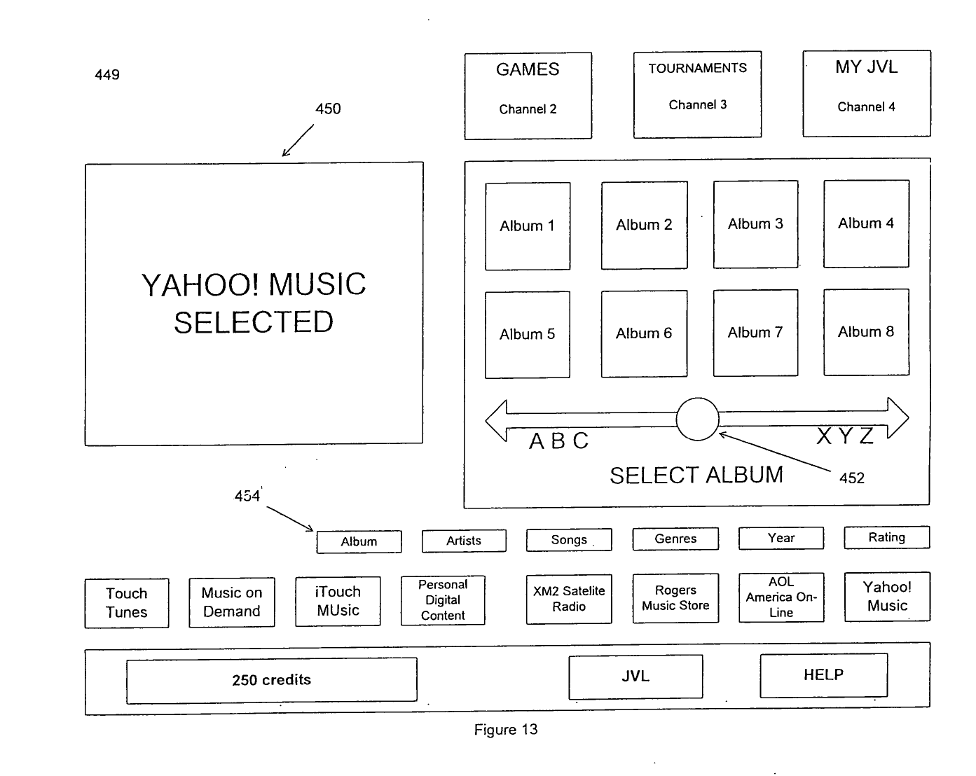

In FIG. 13, the user has selected Yahoo! Music Selected indicated as 450. This is presented in the screen shot indicated as 449. Various albums can be selected or different albums can be selected by using the slide bar control indicated as 452.

A series of control selections are also provided generally at 454 to allow a user to proceed to a desired album more quickly.

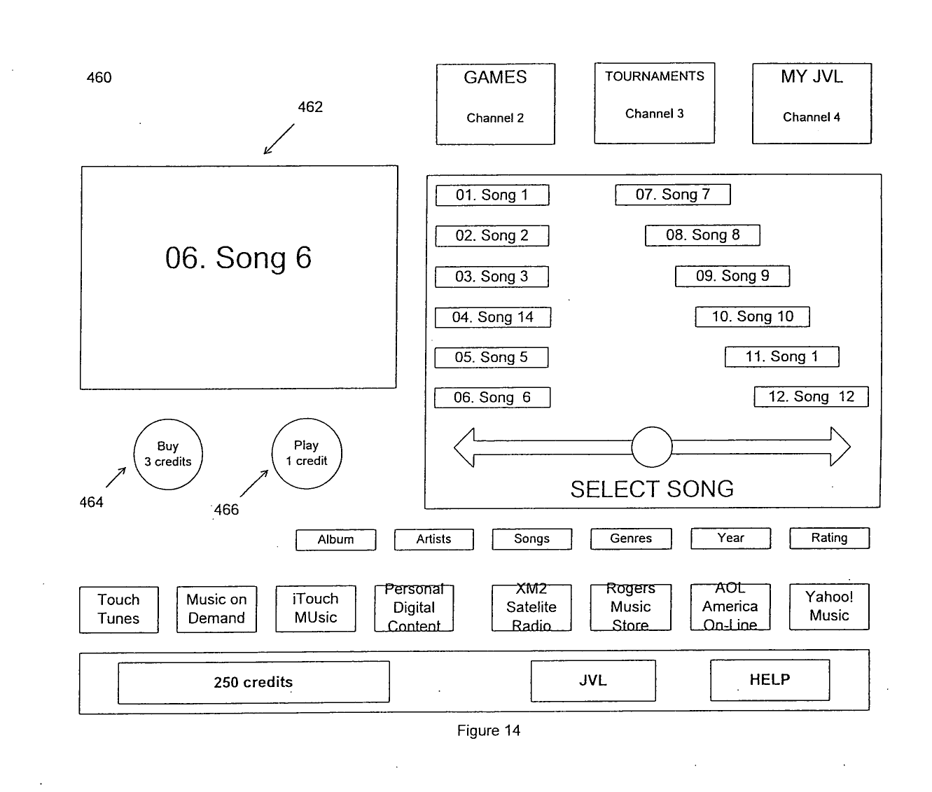

In the screen shot 460 of FIG. 14, the user has selected song 6 indicated as 462. The user is presented different options, namely the “buy” option 464 or the “play” option 466. If the “buy” option 464 is selected, the user would provide a device having appropriate memory storage to the control gate and connected to the same. He could also provide a portable memory device, such as a memory stick. For the “play” option 466, the charge is lower and this digital content can be provided to the control gate or the media center.

It is preferable that the various menus provided to the user allow the user to return to higher levels quickly. For example, the user can merely select the tournament option from the screen shot of 460 to return to these particular selections and options available to him. This allows a fast interaction with the control gate for inputting the necessary information.

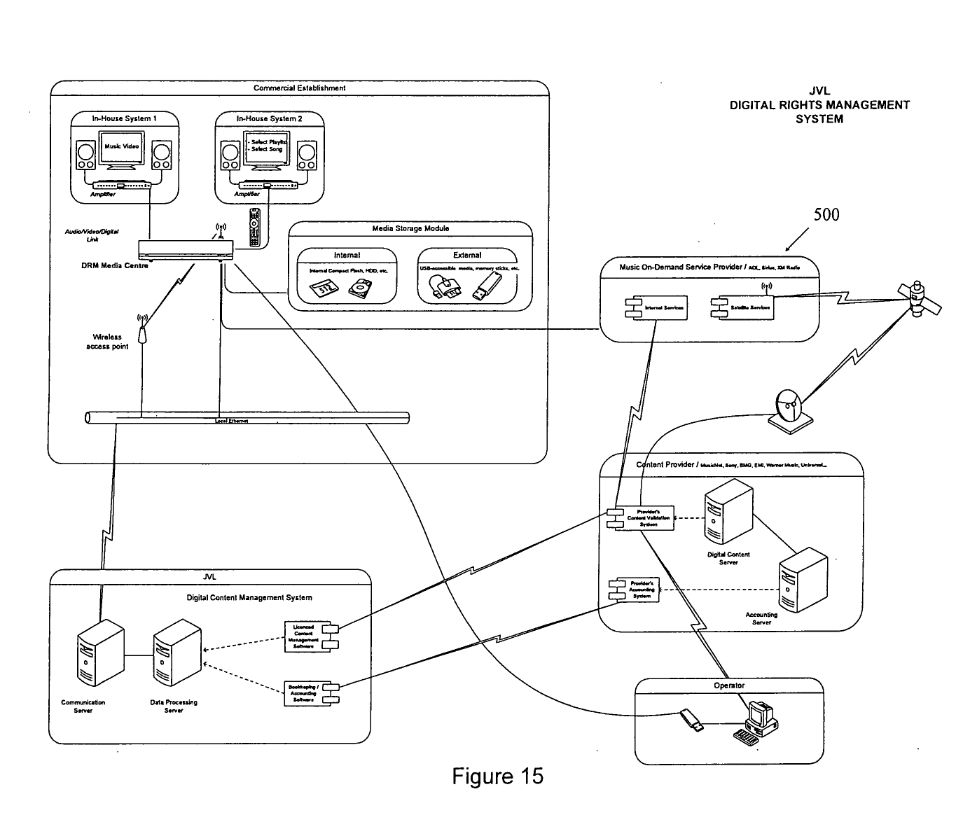

FIG. 15 shows an alternate system including use of portable memory devices for use with the media center for receiving digital content.

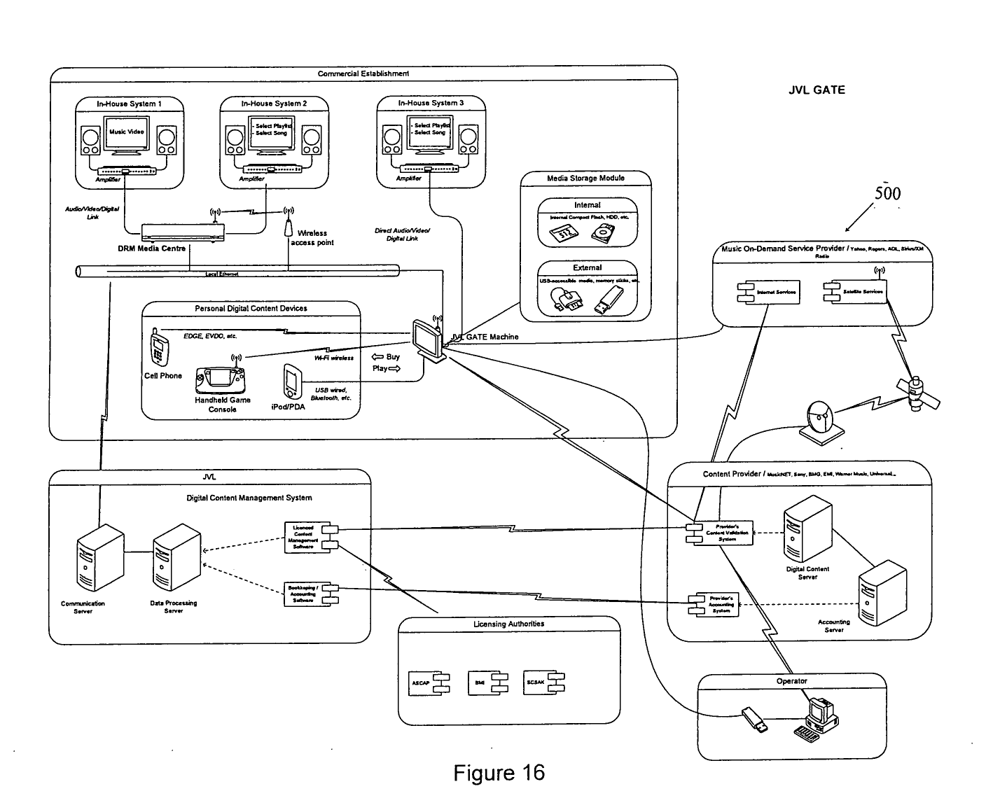

FIG. 16 shows a further alternate system 600.

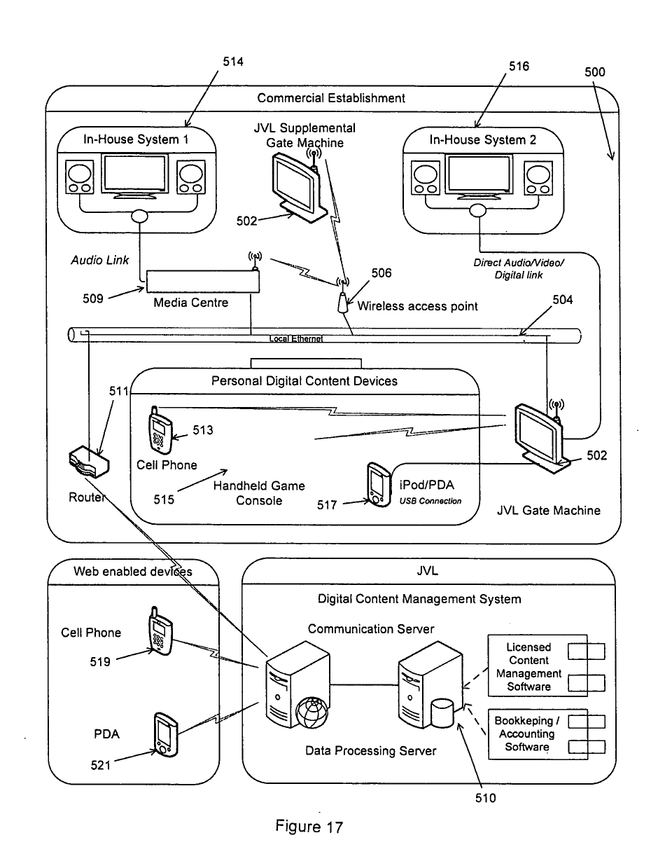

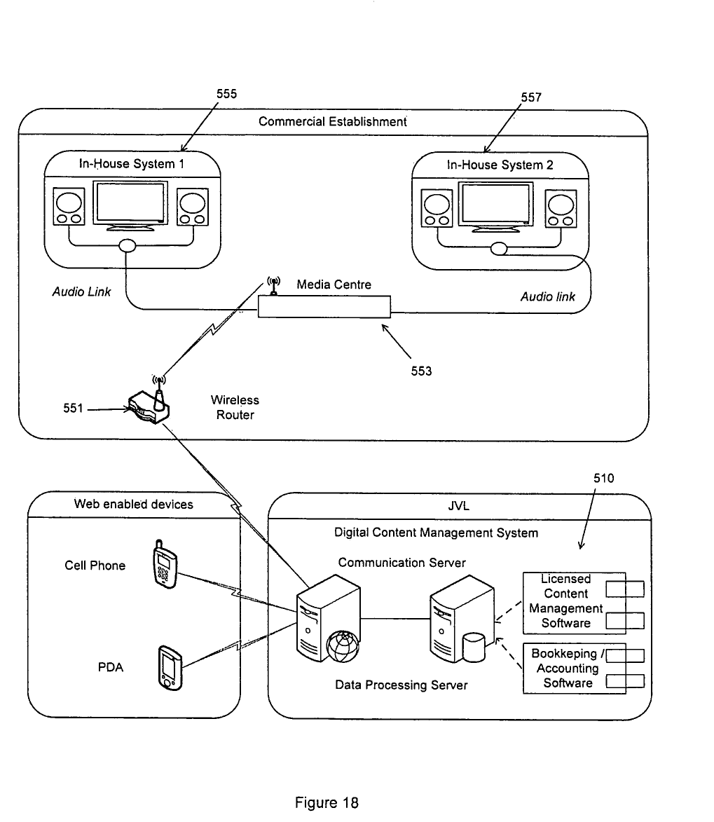

Two modified systems are shown in FIGS. 17 and 18.

The combined system 500 shown in FIG. 17 includes game terminals 502 directly connected to the local area network 504 or connected to the network by a wireless connection through the access point 506. These game terminals can communicate with individuals' personal digital content devices exemplified as the cell phone 513, a handheld game console 515 and an IPod/PDA device 517. As previously described, the user's own digital content can be effectively played on one of the house systems 514 or 516 if certain steps and authorization steps are satisfied as described in the earlier embodiment. The system 500 includes the media center 509 in communication with the local area network 504. The media center 509 is able to receive and play a number of different types of digital records including digital records that are effectively streamed to the media center 509 by the processing server indicated as 510. This data processing server communicates with the media center through the router 511 as one example embodiment.

In a further embodiment, the media center 509 includes its own amplifier associated with a separate output for speaker connections. With this arrangement the media center can output directly to speakers and does not require an in-house system. Connection to an in-house system can be made using separate output channels.

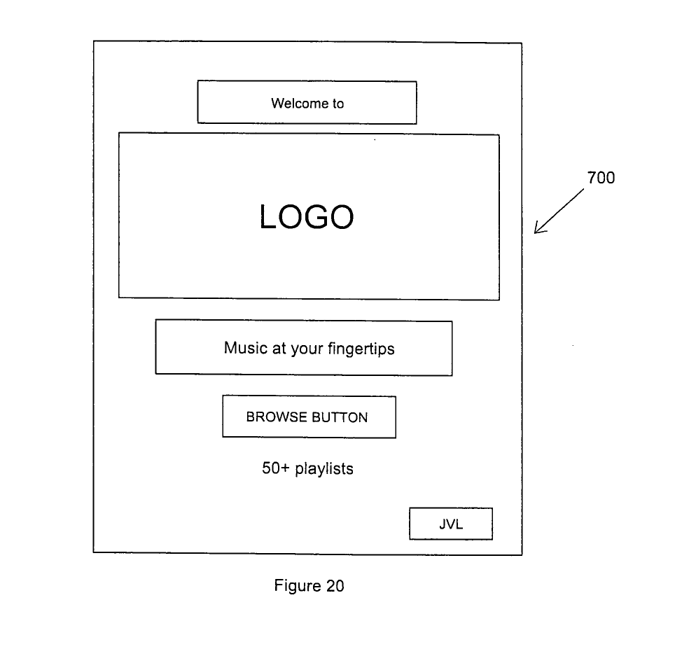

A further embodiment of the modified system 500 is indicated by the web-enabled devices i.e. the cell phone 519 and the PDA device 521. These web enabled devices can communicate with the data processing server 510 using the internet and their particular service provider. In this arrangement, the user can use their own web-enabled device to effectively communicate with the system 500. For example, a user of the cell phone 519 can access the web and form a connection with the digital content management system 510. The data processing server communicates with the system 500 through the router indicated as 511. As a result of the communication between the cell phone 519 and the data processing server, the user has access to various web pages (or menus) that allow for convenient and effective ordering of music that is intended to be played on a particular in-house system such as system 514. The communication with the digital content management system 510 by the cell phone will allow for identification of the particular commercial establishment that the user wishes to communicate with and arrange for the proper ordering of songs. See FIGS. 20 through 22 for an example of the selection process.

When the user connects to the digital content management system 510 various playlists available for the particular location can be reviewed and selected for play. The fee for ordering such songs is charged to the customer's mobile bill by their service provider.

It will also be possible for the user to log in and access their account associated with the digital content management system 510 and access their own playlists and other capabilities as previously described. This modified system also allows for other payment arrangements associated with an earlier authorization of their account. The effective licensing of the material for playback on the system is carried out in the manner previously described.

With this arrangement, a song ordered by a user using his web-enabled cell phone forms a communication between the cell phone and the digital content management system 510 which provides the necessary identification of the content and provides the content and notifies a JVL gate machine on location about the particular digital content to be played. The gate machine 502 adds the song to the location queue list and the song is played in its normal turn. Payment for the song can be based on the user's account or paid by the service provider.

This type of arrangement also can operate with the reduced system shown in FIG. 18. In this case, the digital content management system 510 communicates to the wireless router shown as 551 which communicates with the media center 553. The media center 553 can then appropriately provide the digital content that has been provided from the digital content management system 510 to the appropriate in-house system 555 or 557. The reduced system of FIG. 18 allows for convenient authorization of music by users using their own web-enabled devices. This arrangement can also be used for authorization for game or tournament play on a particular game terminal, and/or the sale and downloading of games to the user's web enabled device.

In order to serve larger locations, it is important to have more than one gate machine 502 available for customers to purchase songs. Customers can purchase songs simultaneously from multiple machines, and in order to process the various requests a mechanism is required for effective queue management. The various requests are entered into a common queue and the playback goes without interruption. In some establishments, there may be separate and distinct in-house playback systems, and separate queues can be available for each such system.

In order to carry out this queuing of digital records, a number of different options are available.

A first option is based on server-based queue management, and in this scheme all song requests go to a common remote digital content management system 510 that maintains an independent queue for each of the locations where gate machines are installed. When the player orders a song via one of the allowed devices, such as a gate machine, a personal device connected to a local area network or personal devices connected to a digital content management system via the web, the request is added to the queue managed by the server for that particular location. The state of the queue is updated by the server via communications by the gate machines and media center installed on location by a particular communication protocol established therebetween. One possible approach for this communication protocol is to have the particular gate machine or media center make a request to the server when a song that is currently being played is close to being completed. The server can then respond with the track ID of the next song in the queue and removes that song from the particular queue.

A different approach for the queue management is a collective management of the queue by the gate machines. Multiple JVL gate machines installed at the same location communicate with each other regarding the particular queue. Each machine keeps a portion of the queue and at any given time one machine is designated as the manager of the queue. When the media center notifies the gate machines that it needs another song the queue manager responds by sending the track ID of the next song in the queue to the media center, removes that song from the queue and sends updated queue information to all of the gate machines at that location. If the machine designated as the queue manager fails to process the request from the media center within specified time intervals, the next gate machine becomes the queue manager and processes the request in a regular manner. The order in which machines are designated to become queue managers is created when machines are connected to the local area network and is updated when any of the machines is turned off or fails to respond to media center requests for a next song. In this scenario, when a song is ordered via web-enabled devices, the server requests one of the gate machines at the location to add this song to the queue.

A further option for queue management is a system carried out by the media center. In this embodiment, the media center has the ability to keep the list of tracked, scheduled digital records for playback. When a user orders a song via the gate machine or one of the personal devices, this request is immediately passed to the media center. The media adds the ID of the song to a list and when the playback of the current song is almost complete, it takes the next track ID from its list, communicates with the digital content management system 510 and receives the stream of digital content. The track ID for the particular song is then removed from the list.

A further modification of the system described in the application is a bidding process associated with the purchase and playback of a song or digital content. In this embodiment, it is possible for customers at the location to compete for control of the in-house audio system to obtain a priority for the play of digital content they have ordered or wish to order. The system provides a discount if the user accepts the premise that the particular selected song will merely be added to the location queue and played in its normal turn. The user, when completing the purchase of a song for play on the system, is presented with the option “Play Now”. If this option is exercised the song is added to the head of the location queue and will be played as soon as the current song is ordered. The second option available to the user is “Play In Turn”. Under this option a discounted price is associated with the playing of the digital record. When the user selects this option the song is added to the tail of the queue and the selected song is played after all of the songs in front of it have been played.

With this system, a bidding arrangement is established and the price of the “Play Now” option is dynamic and is not fixed. When a user selects the “Play Now” option, the system checks the price paid for the song currently at the head of the queue and offers the “Play Now” option at a higher price. For example, player A selects the “Play Now” option first and is charged two credits for that service. Subsequently player B is offered the “Play Now” option to play their song in front of player A's song, for a price of three credits, as player A had already authorized playing for a cost of two credits. If player B accepts the additional cost associated with the “Play Now” option and pays three credits for the song, his selection is placed at the head of the queue. If player C is now presented with the “Play Now” option, the cost for him for this particular option will be four credits. Once the song selected by player A has started to play, the song of player B is moved to the head of the queue. At that point, the price of the “Play Now” option for player C drops to 3 credits. The price of the “Play Now” option is variable; however, the discounted price for the “Play In Turn” option preferably always remains the same.

In a variant of this bidding process, a fixed price for the “Play Now” option can be used. In this case, there are two priority lists, one for players who opt to pay full price, and the second for those who selected a discounted price. For example, player A selects the “Play Now” option and is charged the full price of two credits. The song ordered by player A is placed at the head of the queue. Player B selects the “Play In Turn” option for a discounted price of one credit and that song is placed at the end of the queue. Player C subsequently selects the “Play Now” option and that song is placed after the song of player A and before the song of player B. If player C selects the “Play In Turn” option, that song is placed at the end of the queue.

A further feature of the present system is possible in that the digital content management system 510 is serving multiple locations in various geographic locations. As a result of this authorization step, the digital content management system 510 tracks songs that are popular in different geographic locations. As part of the play selection, a user can select a particular geographic location and the server will provide a printed menu of the most popular songs played at that particular location or geographic region.

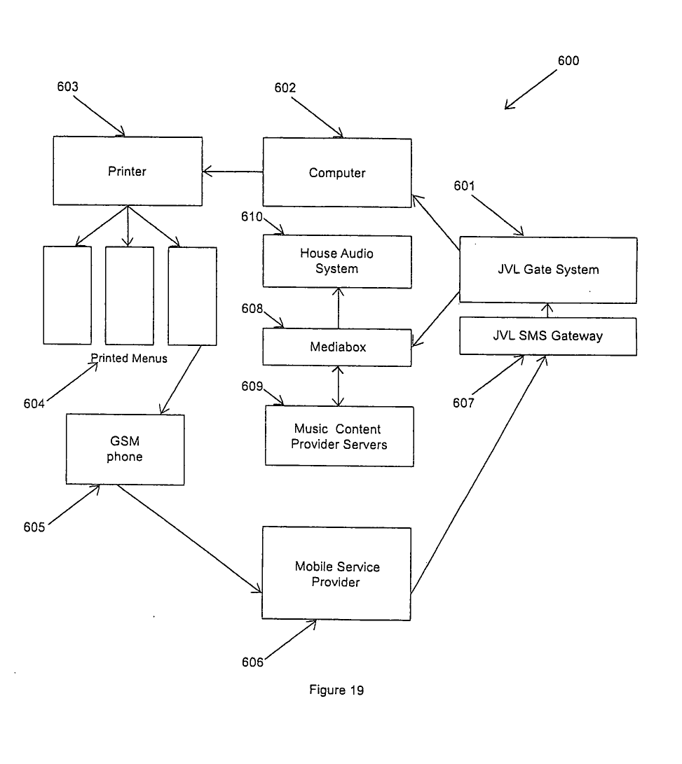

FIG. 19 is a schematic overview of an alternate embodiment of the system that allows for ordering of particular audio or video digital records for play on a public system such as found in a restaurant or bar. The system 600 allows any GSM phone or device to order music or other digital records for play on an in-house audio system 610. The system includes a gate system 601 that provides a web interface to a computer 602 used by a location or other user. This computer preferably includes a printer 603 that allows the user to print menus of musical selections. These menus can be customized by the particular operator for his location if he prefers to have a certain type of music played in his establishment. It is also possible to select menus already available on the server. In any event, a series of printed menus are created or selected by the operator and printed by the operator. These printed menus are then made available at the individual tables and other locations for review by the patrons. The gate system 601 simplifies the creation of these menus and provides documents suitable for printing by the operator.

The menus provide a listing of possible selections and each of these selections includes a unique number or code that identifies the various songs as well as the particular location of the establishment. The end user (i.e. the patron) uses this unique number or code to order the song by means of a text message as will be further described. As the location information is also associated with this unique number or code, the particular selected song can be provided by the server to the media box indicated as 608 for eventual play on the house audio system 610. Depending upon the particular licenses provided, this digital record can be provided as a streamed digital signal or can be provided for temporary storage for play or can be accessed in a controlled manner from a database. Therefore, there are various approaches for providing of the actual record for play on the system and there are various systems that allow for the proper authorized play of such records and the appropriate payment to the authorized body. All of these systems include various tracking capabilities.

The patron, who may be in a restaurant, for example, has provided to him the various musical menus. These menus can be separately provided, or can be provided in association with the food and beverage menus. Any selection on the menu may be ordered in a number of different ways, but preferably includes using a SMS text messaging arrangement. The end patron using, for example, his cell phone with GMS capability, directs a text message to the SMS gateway indicated as 607. This is provided to the gateway 607 by means of the mobile service provider indicated as 608. Customers that are interested in ordering the song enter the code printed and may also provide the song name. This information or at least the unique code is sent as a SMS message to a phone number address indicated on the menu. The message reaches the mobile service provider indicated as 606 and it is forwarded to the SMS gateway 607. The gateway accepts the message and communicates this message to the gate system indicated as 601. The gate system 601 processes the number supplied in the message to identify the location from which the request was sent, and to also identify the particular song selected.

These menus can also be used by a patron to order a digital selection by communicating this information to serving staff of the establishment. The serving staff send this information to the server and charge the patron.

The gate system 601 identifies the address of the media box 608 provided at the particular location, and this media box is connected for effective communication with the various music content providers 609 and the JVL gate system 601. The gate system 601, on receiving a particular request, identifies the particular ID of the media box to be sent the digital record, and creates an order that contains all the information required by the media box to facilitate playback.

The media box 608 receives the order and authorizes itself on the network having the associated music content provider servers indicated as 609.

Depending upon the particular arrangement for play of authorized digital records, the media box will receive the record for play on the in-house system indicated as 610. In the example shown, this is an audio system, but it could equally be a combined audio/video system or a video system.

Payment arrangements can vary from prepaid arrangements to charges to the user's device or associated with the patron's bill. This last option typically requires the patron being given an authorization code that is provided to the gateway system 601 and confirmed to the establishment's billing system.

The above system describes a particular arrangement for the convenient production of musical menus that allow an operator to provide customized playlists to his patrons for selection. It also describes a simple arrangement for ordering of such music using text messaging. One of the prime advantages of text messaging is the low cost associated therewith and the popularity of text messaging in general.

Other arrangements for ordering of music can also be provided using the text messaging arrangement generally described. For example, it is also possible for an end user to send a text message to the SMS gateway 607 and the gateway provides an appropriate reply message that allows a user to select a particular song for play. This original text message will include preferably the location for the song to be played and perhaps a code for the desired category of the desired selection. The reply text could also include such categories as title, artist, album name, etc. that can be effectively filled in or copied and filled in by the end user for further forwarding to the SMS gateway 607. Basically, the end user can start to qualify the particular musical requests. If this second message is sufficient to uniquely identify a particular musical selection, a return text can be sent identifying the particular record and seeking confirmation. If the particular selection criteria has not uniquely identified a particular selection for play, a return message can be sent to assist the end user in selecting a particular record. For example, if the end user is merely sent information with respect to a particular artist, a number of albums of that artist can be sent in a return text to assist the user in identifying a particular album. Once a particular album has been selected by the end user in a further text sent to the gateway, the gateway can then return the particular records of that album allowing the end user to make a final selection and confirmation.

With this text ordering system, the user's device is uniquely identified and as such the gateway 607 and/or the server associated therewith can include information with respect to the user's previous selections or preferred music selections. This information can be used to simplify the ordering process.

The above-described systems have assumed that the end user is in the location that he wishes the particular musical selection to be played. It is also possible for this system to allow the particular musical or video record to be played at a different location identified by a unique address. For example, a person may know of a particular party at a particular location having this type of system. That user can effectively order a song for play at that particular location using this system. Effectively, he can send a text message to identify the particular location and the particular song that he wishes to have played and perhaps even a particular time or general time at which the song is to be played. This type of remote ordering for play at a different location can also apply to web-based enabled portable systems of users. In this way, a portable web-based enabled system can access a server, select a particular location in which a song is to be played, and then identify that particular song. Suitable payment arrangements are settled, and the particular song or digital record can then be queued for play at that location in accordance with the instructions. Such instructions can also include particular time periods and perhaps other information such as a dedication or other message for a particular patron.

The actual payment arrangement can take any of a host of known forms.

The present application describes how a user can use text messaging or an Internet communication to order music at a particular location. FIGS. 20 through 25 show a series of screen shots where a user has completed a transaction for the play of a musical selection at a particular selected location using a web based arrangement.

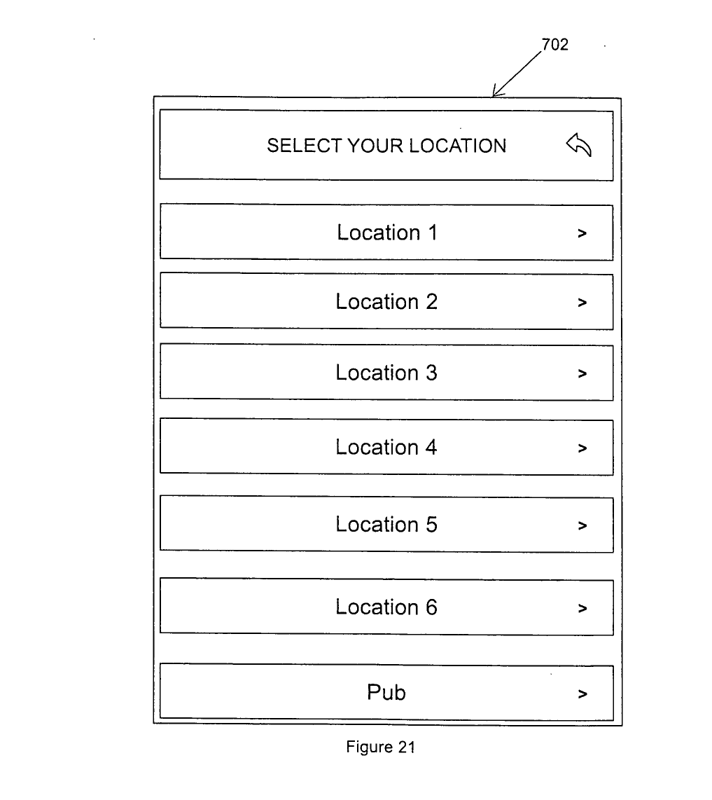

The screen shot 700 in FIG. 20 is the initial screen presented to a user who has used his web-based enabled personal device to access the iTouch music web page at iTouchMusic.com. The user then appropriately selects the browse button which presents the location identification screen shown as 702 in FIG. 21. This is a partial screen shot having a series of locations identified as 1 through 6 and a pub location identified. The user can select any of these locations, and these locations define where the particular selection will be played.

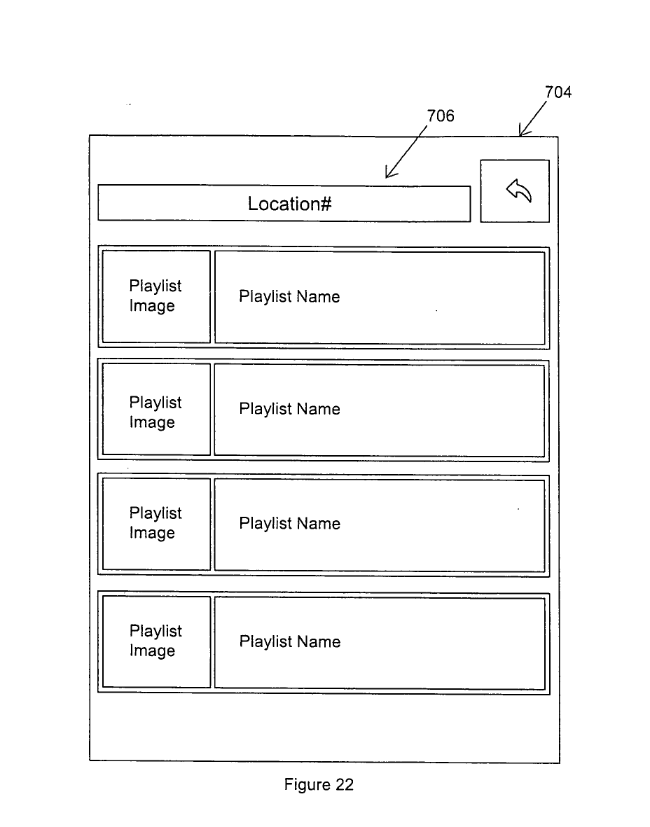

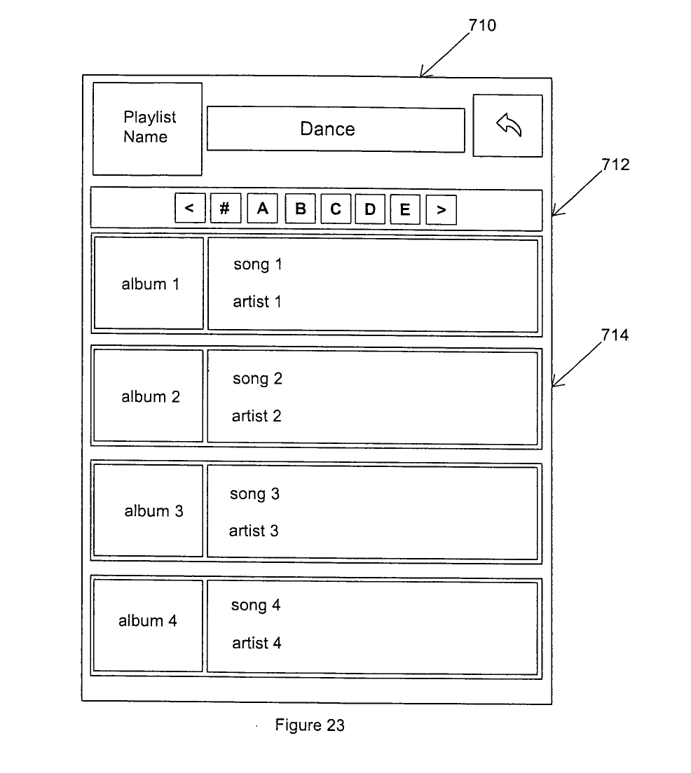

FIG. 22 shows screen shots 704 where the user selected location 1 and this is identified at 706 in the screen shot, and various further categories are shown as “alternative”, “classical”, “country”, “dance”, etc. This screen allows the user to further define his particular selection the “dance” category 708 is activated, and the user is taken to the screen shot 710 shown in FIG. 23. This is only partial screen shot, and is a scrollable selection, or one can use the alphabetical qualification indicated as 712.

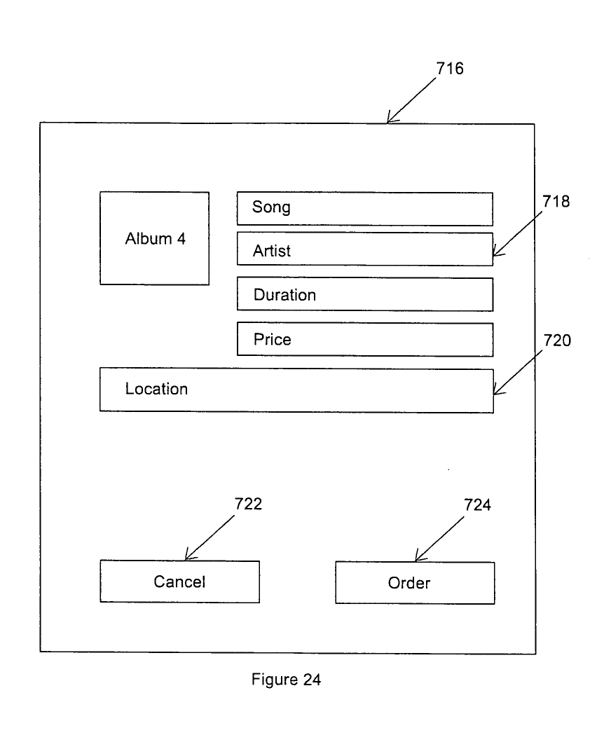

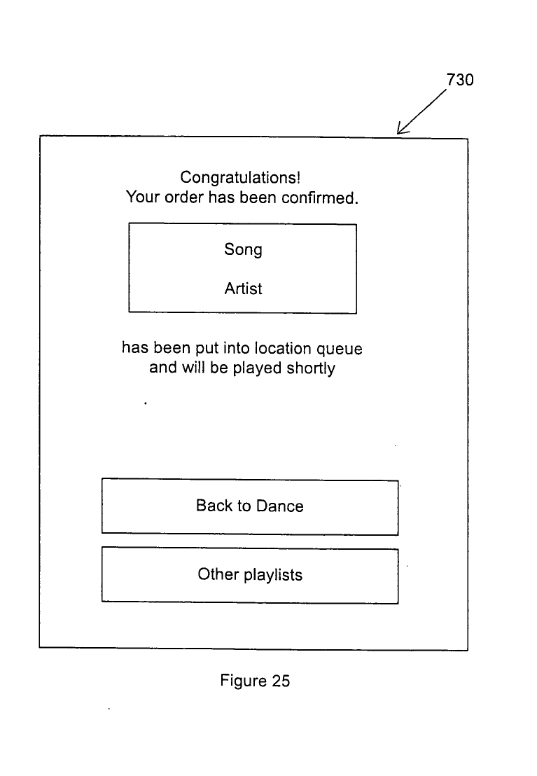

In this case, the user activated the selection indicated as 714 and is taken to the screen shot shown as 716 in FIG. 24. Details of the particular selection are shown at 718 and the location where the record will be played is shown at 720. The user is then presented with the option to actuate the cancel button indicated as 722, or to confirm confirmation of the order by actuating the actuator 724. By actuating the actuator 724, the person is taken to the screen shot 730 shown in FIG. 25. The particular selection has been confirmed, and confirmation that the selection has been placed in the location queue has been provided. There are various options that may be available to the user, such as paying a premium for play of the particular selection at a specific point in time, or in preference to other selections as has been previously described. With this system, the user is able to use his device for communication with a web server for play of a particular recording at a particular location and in a particular manner or queue.

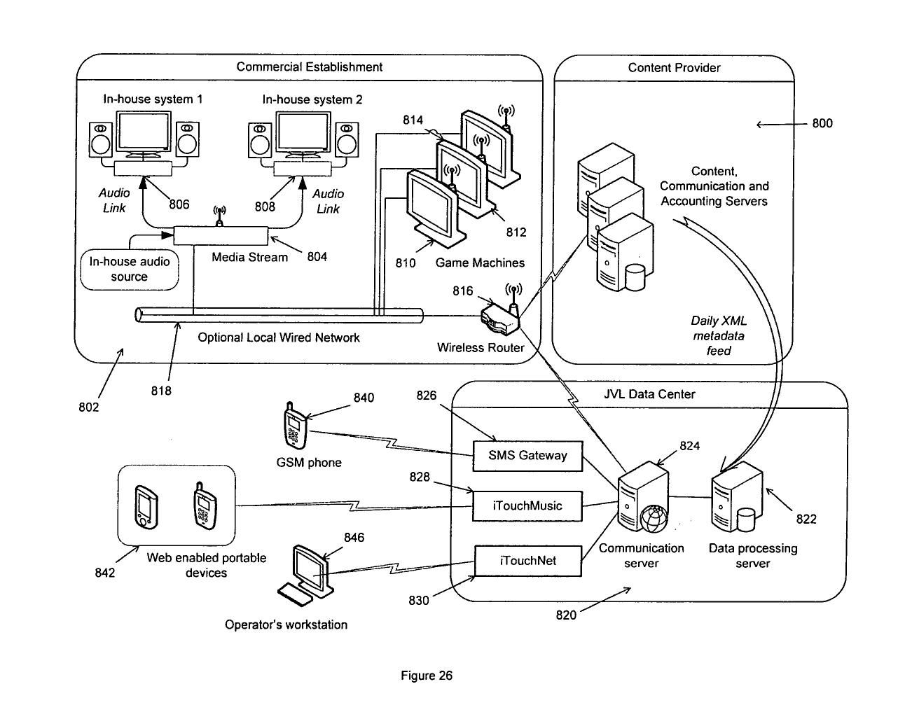

FIG. 26 is similar to the other figures, and illustrates the particular cooperation between the system 802 located at the commercial establishment, the content provider 800 and the data center 820. The system within the commercial establishment 802 includes the media center 804, which is able to control the audio input to one of the two in-house systems 806 and 808. The media center 804 is connected on a local network 818 and is in communication via the internet and a router 816 with the content provider 800 and the data center 820. Other arrangements for the media center 804 to be connected to the Internet or to be in communication with the content provider 800 and the data center 820 can be used. For example, cellular data communication could be used for communications other than the streaming of digital content that requires a high speed connection. If digital content is provided locally a high speed connection would not be necessary while providing the convenience of ordering and/or authorizing the play of digital audio and/or video content.

Various game machines 810, 812 and 814 are shown connected to the network 818 and can act as terminals for the media center to accomodate the selection and playing of music, and can also act as game machines. Ordering of music can take place by a user using a mobile phone indicated as 840, which allows for text messaging, and is connected to the SMS gateway 826. It is also possible to use web-enabled portable devices indicated as 842 for connecting with the iTouch music web page. Furthermore, it is possible for a personal computer indicated as 846 to access the iTouchNet webpage for different functions including the order of music. The data center 820 includes a communication server 824 and a data processing server 822.

The media center 804 is a compact device that is in communication with and controlled by the communication server 824 and the data processing server 822. The media center 804 is also in communication with at least one content provider indicated as 800. DRM (digital rights management) protected streaming content is provided from one or more of the content providers to the media center 804 and the media center 804 may decrypt and decode the content.

The communication server 824 and the data processing server 822 of the data centre 820 are responsible for processing music orders received from any of the game machines 810 through 814, and from the various phone and web enabled devices 840 and 842. These music orders identify the particular content that is desired to be played, location information and the servers communicate with the media center 804 and provide the content identification information. The media center 804 then communicates this request to the content provider 800.

The data processing server 822 and the communication server 824 of the data center 820 also obtain and store music, catalogue metadata (track name, author, release date, etc.) from the content providers in the form of daily data fees. These servers also provide reporting and media center configuration functions to operators via the iTouchNet website. This basically allows operators to customize the system according to their own need and the particular location remotely in preparation for a site installation.

The content provider keeps track of every song delivered to a media center, calculates necessary royalty payments, maintains accounting records and bills the data center 820 for the use of the content. In FIG. 26, all of the content originates with one of the content providers, however there can be multiple content providers.

The game terminals 810 through 814, in addition to providing gaming functions, also accomodate music selection input whereby patrons can order music preferably using an innovative 3-D graphic user interface integrated with the gaming functions provided on the terminals. These game terminals allow the users to access a variety of playlists prepared by data center 820. In this way, the network of media centers 804 are all updated on a regular basis. In addition, the media centers have location ID, and the operators can use their computer 846 to provide to the data center the custom music content that should be provided. For example, there may be certain types of music selections that a particular location does not wish to offer, or the operator may be very selective in what music content is available for play. The data center 820 can then update the particular media center in the most appropriate manner.

The servers of the data center 820 obtain the catalogue-type information regarding music tracks etc. from the content providers. After this information is received, it is processed by the data processing server 822. The information is optimized for search efficiency and to address licensing and configuration restrictions. Due to the dynamic nature of the music industry, this catalogue information is constantly changing. New tracks are added, artists switch labels, labels are sold, and rights for tracks performance are revoked. To keep the catalogue up to date, the data center servers replace obsolete data and add new data. Typically, a few thousand tracks are added, and tens of thousands of records are updated on a weekly basis. To accommodate easy access to popular tracks, the data center 820 builds and maintains a number of playlists. These playlists represent different genres (rock, pop, reggae, etc.) and different themes (seasonal tunes, love songs, hits of the 1990's, etc.). Typical playlists contain between 100 and 200 songs.

To prepare a particular location to provide music, an operator needs to register the media center device. Each media center device has its own unique identifier, and the operator needs to assign this ID to a specific location using the iTouchNet website. This association is stored by the data center servers, and is necessary for the system to send music orders to a correct location. Using the same website, the operator can configure the media center device to accommodate location preferences. The options include the ability to hide some of the prepared playlists, the ability to block specific genres, and/or playlists, set up demo options, and create location-specific playlists. After the media centre is properly configured, it is installed at the location and connected to the INTERNET using, for example, WIFI or an ETHERNET connection. In-house audio video systems are connected to the media center outputs, and in-house audio source, such as a radio or CD player, is connected to the media center using the auxiliary input. The media center can also include an amplifier for increasing a signal before outputting.

When the media center is turned on, it first connects to the data center servers and identifies itself by its ID, software version and calculated cache of the software binary image. The servers verify, that the software version is up to date, and that the software is not corrupted by comparing provided cache value with the one on record. If the software is found to be outdated or corrupted, the servers instruct the media center to download new software, and to repeat the identification process. If the media center software meets requirements, the server looks up the location of this media center by its ID and updates the status of this location as ready to serve music. After successfully connecting to the servers, the media center connects to the content provider and authorizes itself as a recognized device using credentials given to it by the data center servers. Once this is complete, the media center is ready to accept orders.

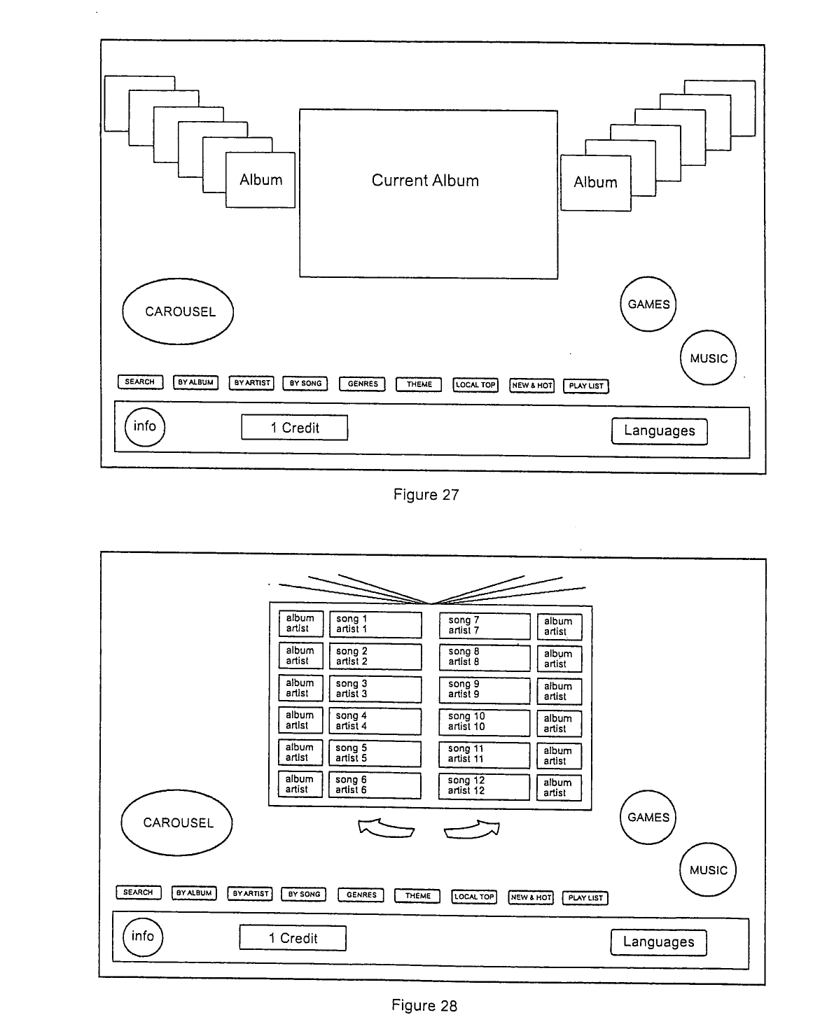

The most common way to order music on location is through the game terminals 810, 812. In addition to a large selection of games and tournaments, these game terminals have a graphic user interface (see FIGS. 27 through 30) for selection of music tracks by browsing through a set of pre-loaded playlists or by searching the whole catalogue. When the game terminals are turned on, the terminal verifies whether the music option has been enabled by the operator. The game terminal will connect with the data center servers and check for updated playlists. If any of the playlists are out of date, they are downloaded from the servers in the background without interrupting the terminal's ability to play games or order music. Playlists do not contain actual content of the song, only its title, unique track ID and other essential parameters. For presentation of those playlists on the user interface, the terminals download low resolution album art from the servers of the content provider and cache these images for performance reasons.

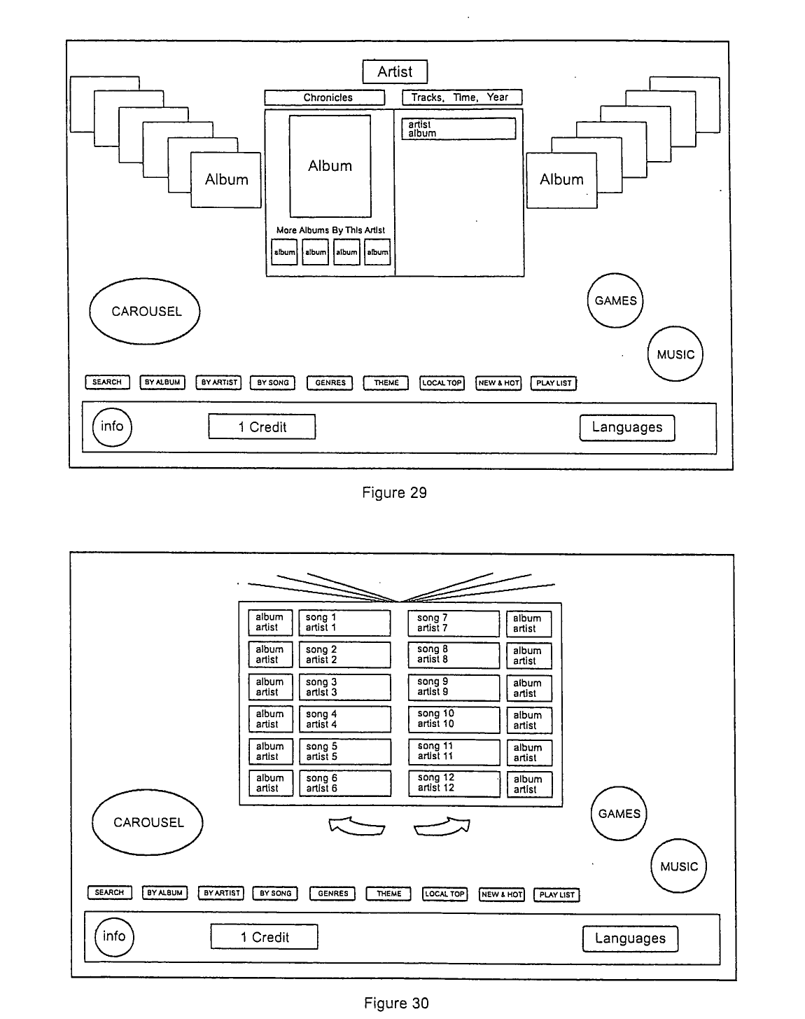

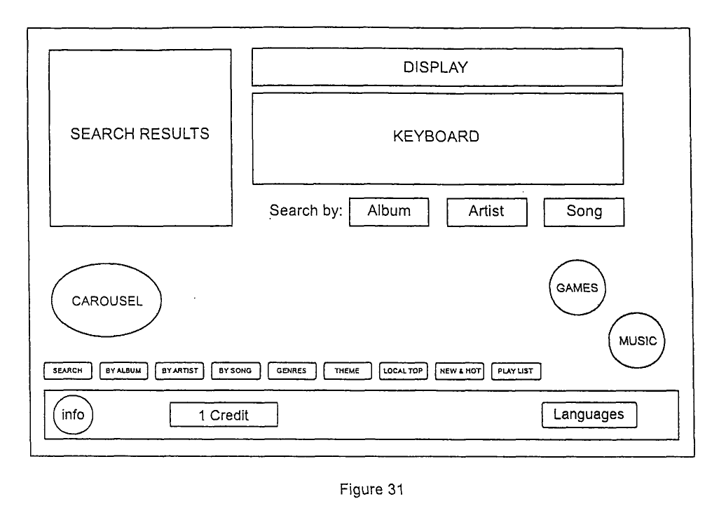

The user selects one music track by using machine browsing and search features. The user can browse by selecting specific playlists (see FIG. 30) or by using the Artist/Album/Song browse option (see FIG. 29) that combines the songs from all of the playlists and sorts accordingly. Additionally, the user can search for the music by typing in first letters of the Song or Artist Name or Album Title (see FIG. 31). This search is interactive, meaning that as soon as the letter is entered into a search box the machine sends the request to data processing server 822 which returns the list of matching entries. Users see the top of the list in the search window and can either type more letters to narrow down the list or scroll down to select the track they are looking for.

Once the user confirms song selection, the machine verifies that the user's credit balance is sufficient to pay for the selected song. After that, the machine sends the request to the data processing server 822. The server looks up Media Center for that location and sends the order to it, and sends confirmation back to the machine that the order has been accepted and the user can be charged for the song.

Upon receiving this order, the Media Center requests the content of the song from the Content Provider identifying the song by its unique track ID. The Content Provider verifies access rights for the track and starts sending the content down to Media Center in the form of network packets where each packet contains a small, preferably less than one second, portion of the song. This process is usually called streaming. When necessary, the content is protected by DRM (digital rights management) technology that the data center 820 and Content provider have both licensed from Microsoft, for example.

Each packet arriving at Media Center is placed into a circular buffer in RAM. As soon as the content in the buffer is sufficient for a few seconds of playback, Media Center starts decrypting the packets one by one. Decrypted packets are decoded from compressed audio format, converted to analog form and passed to the outputs of the Media Center. Once the original packet is processed it is discarded from the buffer. Following this process Media Center works its way through the content of the song and at any given time only a small fraction of the song is present in the RAM of the Media Center. Once the last packet of the song is processed by the Media Center it notifies the data center 820 that it is ready for the next track. Upon receiving ID of the next track, the Media Center will start filling its circular buffer with the content of the next track while the end of previous track is being played back. This method of advancing the playback queue avoids pauses between playback of subsequent tracks that otherwise would be inherent to streaming way of delivery.

The technology disclosed herein is not limited to ordering music through game terminals. It allows users with mobile devices to request their music directly from the data center 820. Basically the data center is available to receive music orders from different devices that can communicate with it including user owned devices.

For example, a user with a web enabled portable device, such as a phone or PDA can order music. Users are advised to navigate to the iTouchMusic web site, for example, which gives access to the same playlist browsing and search functions, optimized for online access via a small form-factor device. Upon connection with a portable device, the data processing server uses several techniques to identify the location of the user, or to at least narrow down the list of possible locations. When location of the user is not 100% certain, the user is presented with a reduced list of possible locations and is asked to confirm where he or she currently is. The users can browse the site freely and will see the same content (including location specific options and playlists) as users of the game terminals. When the users attempt to order music they will be advised to purchase music credits by sending SMS to a specific number. That SMS is delivered to the data processing servers via an SMS gateway.

Once such SMS is processed, a requested number of credits is added to a temporary account and a SMS response is sent to the user. This response includes the iTouchMusic URL with unique access code allowing players to automatically return to the site and get access to the credits they purchased. Having credits users can finalize their order. The order is processed by the data processing server in a fashion similar to orders submitted through the game terminals. The major difference is that in the case of an online order the server is responsible for charging the price of the song to the user's credit balance. The charge for credits purchased on the site will be added to user's wireless bill by their carrier. After the bill is paid the carrier will transfer the funds (less service fees) to the data processing server, which in turn will aggregate those payments and send appropriate payment to the Operators of the site equipment.

Alternatively, the users can pay for the music purchased online using their credit card or Paypal account.

A further method allows users to order songs by using a code printed on a menu and sending an SMS message with this code to a specific phone number. To prepare this menu, an Operator generates a special playlist and converts it (using appropriate function on iTouchNet site) to a music menu, where each song has a unique code that identifies both song and the location. The file with Song/Artist names and codes is exported by the site in one of the convenient formats, and printed by the Operator. This printed menu is distributed together with the regular food menu or wine list. Location patrons browse the menu and select the song they would like to hear. To place their order they send the code of the song via SMS to a specific number, as instructed on the menu. The data processing server receives this request via a SMS gate and processes the code to identify location and track ID. After that the order is sent to Media Center of that location. Payments are processed similarly to online ordering method. Alternatively, a payment arrangement can be provided by the location that is authorized. In this way, the cost can be added to a bill.

Players can also order multiple songs at the same time by entering several codes from the menu into SMS message.

Having multiple sources of ordering requires that a queue of orders is maintained for a location. This queue is maintained by data processing servers. The communication protocol between the data processing server and the Media Center is designed to be bi-directional, meaning that it allows either party to initiate music playback. When the Media Center finishes processing network packets for a current track it sends a request to the data processing server to check whether there are any other tracks in the location queue. If the queue is not empty, the data processing server responds to the Media Center with the ID of the next track to play and advances the queue.

Having the queue maintained on the data processing server allows processing of orders using different approaches and optionally can allow users to bid on the position of their song in the queue. The price for placing the song at the head of the queue is higher than a regular payment. When the first user pays a premium to place his or her song at the head of the queue the price of head placement increases, allowing other users to outbid the first user and get their order executed first. Operators are given the ability to disable this option or modify this option.

With the ability to order music online and/or through the menu it is possible to use a Media Center at a location that does not include game terminals.

The main drawback of streaming technology is that once the connection to the Internet is interrupted the music cannot be played and some locations may not have high availability networks installed.

Storing a selection of most popular content on the Media Center by itself does not solve the problem, because in this case content played from a backup storage without Internet connection will not be accounted for by the servers of the Content Provider and royalty payments will not be calculated properly, Also, if the content is stored in one of the common formats it could be stolen and otherwise misused.

To address this issue a comprehensive Music Backup Service based on DRM technology is used. The solution consists of the following components:
Storage device that could be attached to Media Center (such as high capacity USB Flash drive) that carries selection of songs included in the created playlists. The songs on the device are stored in DRM protected format and cannot be played by a third party if that party acquires the device without authorization
Subscription service from Content provider. The service allows the Media Center to obtain a so called root license that will enable it to play all of the songs on the device for a limited amount of time (for example 1 month)
A backup management software is provided on the Media Center and allows it to manage acquisition of licenses and content updates on backup device.
   In order to use Backup Service, Operators purchase a subscription from the data processing servers. The price of the subscription covers occasional use of the content stored on the device for the purpose of covering Internet connectivity downtime periods. Operators are able to use Backup service for as long as they are paying subscription fees. As soon as their subscription is canceled, the device becomes inactive and cannot be used to play songs. Similarly, if the device is lost or stolen, the content of the files cannot be decrypted and played back.

The Backup Service operates in the following way:
Operator subscribes for the service, gets the device and plugs it into the Media Center
Every time the Media Center is turned on it connects to the data processing servers and checks whether its Operator has valid subscription for Backup Service
If subscription is valid the Media Center checks the expiry date of the root license
If the license is about to expire (less than 5 days left or a predetermined period) the Media Center obtains a license for a further 30 days from the servers of the Content Provider
During idle periods (when no music is being played) the Media Center verifies that the content on the backup device is up-to-date using information provided by the data processing server. If the playlists have changed, the Media Center downloads new DRM protected content from the servers of the Content Provider
When an Internet connection is available, music ordered by patrons is delivered directly from the servers of Content Providers as described above
When the Internet is interrupted, the game terminal communicates with the Media Center on the local network. After the connection is established the game terminal disables search and dynamic playlist (such as Top 100) options
Patron orders a song from one of the limited prepared playlists
The machine sends the order to the Media Center over direct connection that it has established earlier
The Media Center locates requested content on the backup device, decrypts it using root DRM license and plays the content
The Media Center periodically tries to reconnect to the data processing server. Once the connection is established, the Media Center closes all local connections to game terminals and resumes operation in regular mode.
   The Content Provider keeps track of all root licenses obtained by authorized Media Center devices and charges the data center 820 accordingly.

The game terminals also allow a user to search for a particular song using different criteria. This could include the title, the artist, the album, etc. In order to conduct this search, an option provided on the game terminal is actuated which effectively connects the game terminal with the servers at the data center 820. In this way, the individual game terminals do not need to store a host of information as the searching of the database is carried out on these remote servers.

Examples of the user interface provided on the game terminals are shown in FIGS. 27 through 30. Basically the Music option is selected on the touch screen at the bottom right hand side, and various options for presenting of the music content can then be selected and modified. FIG. 31 shows an example of the screen shot provided where the user wishes to search for a particular music selection on the servers of the data center 820.

The present music system for use in a commercial establishment has a number of advantages over existing systems. In particular, the system can advantageously use an existing in-house audio system for reproducing of the music. The digital content is outputted from the media center to the in-house system for play. A further feature of the system is realized by separating of the ordering and playback functions and providing a number of different options for completing these functions. In one embodiment, music is ordered through the game terminals which include a user interface for music selection, browsing, searching and ordering. Music can be ordered from a number of different game terminals installed at the same location and those terminals can be configured to turn the music option on or off. In addition, these terminals can be scheduled to selectively turn the music option on at different times or under different conditions. For example, it may be desirable if the music option is only available at certain times during a day, such as after 6:00 pm. The game terminal can function purely as a game terminal during the other times.

With the present system, patrons can order music on location using their web enabled phone or other web enabled device and accessing a particular website. The website is maintained by the data center and a number of different approaches can be used to identify the location that the music is being ordered from. Payment for the music ordered can be completed using music credits purchased by sending an SMS message to a specific phone number. The mobile carrier will add those charges to the wireless bill of the customer, and transfer the proceeds less any service fee to the provider of the music. Proper tracking of the performance of the music is always followed.

The present application also discloses an option of providing a menu of various music selections, and providing different codes for these selections. A SMS message may be sent to a particular phone number, and the code entered to identify the particular music selection and to also identify the location.

With the present system, operators and location owners can manage the music preferences and they have various reports provided by a web based interface. The interface allows them to select which of the different pre-built playlists should be shown to their patrons, block certain music genres and/or tracks with explicit lyrics, and set various prices. It also gives the ability to create location-specific playlists and upload custom graphics (such as the photo of the playlist creator)to identify those playlists on the game terminals.

Although various preferred embodiments of the present invention have been described herein in detail, it will be appreciated by those skilled in the art that variations may be made thereto without departing from the spirit of the invention or the scope of the appended claims.

The embodiments of the invention in which an exclusive property or privilege is claimed are defined as follows:

1. A system for play of digital content in a public establishment comprising:
a digital content play system;
a media center connected to said digital content play system and in communication with a remote web or text accessible digital content server to receive digital content; and
independent web or text enabled devices of independent users allowing access to said web or text accessible digital content server and selecting and authorizing payment of digital content for play on said digital content play system;
said remote web or text accessible digital content server communicating with said digital content play system and at least authorizing play of a selected digital content;
said media center providing to said digital content play system said digital content for play thereof on said digital content play system.

2. A system as claimed in claim 1 wherein said media center receives said digital content as streamed digital content.

3. A system as claimed in claim 1 including terminal devices located in the public establishment and in communication with said digital content server, said terminal devices including software allowing users to select digital content for play on said digital content play system and said terminal devices communicating said selections to said digital content server, said digital content server thereafter providing said digital content to said media center as streamed digital content.

4. A system as claimed in claim 2 wherein said digital content server includes a queue management function for the system and provides streamed digital content to the media center based on the queue management function.

5. A system as claimed in claim 3 including a queue management system allowing a user to select a higher price option for earlier play of selected digital content.

6. A system as claimed in claim 5 including a fixed price for play of digital content added to the end of a queue of the queue management system.

7. A system as claimed in claim 6 including a variable price for the play of digital content to be added to the head of a queue of the queue management system.

8. A system as claimed in claim 2 wherein said media center includes a queue management function for establishing the order of play of digital content and instructs said digital content server with respect to the next digital content to be played.

9. A system as claimed in claim 1 wherein said remote web or text accessible digital content server is capable of communicating with both web enabled and text enabled independent devices of independent users.

10. A system for play of a digital content in a public establishment wherein said remote accessible digital content server includes a text messaging communication function for receiving text messages authorizing digital content for play on said digital content play system; whereby
independent text enabled devices of independent users can access said digital content server using said message communication function to order digital content for play on said digital content play system.

11. A system for play of a digital content in a public establishment comprising:
a digital content play system;
a media center connected to said digital content play system and in communication with a remote accessible digital content server to receive digital content from said digital content server;
said remote accessible digital content server including a text messaging communication function for receiving text messages authorizing digital content for play on said digital content play system;
independent text enabled devices of independent users allowing access to said digital content server using said message communication function to order digital content for play on said digital content play system;
said remote accessible digital content server communicating with said digital content play system and at least authorizing play of ordered digital content; and
said media center providing to said digital content play system said ordered digital content for play thereof on said digital content play system.

12. A system as claimed in claim 11 wherein said text messaging communication function includes SMS communications and at least some of said independent text enabled devices communicate with said digital content server using SMS messaging.

13. A system as claimed in claim 12 wherein said remote accessible digital content server is additionally web accessible and wherein independent web enabled devices of independent users can access said web accessible digital content server and order and authorize payment of digital content for play on said digital content play system.

14. A system as claimed in claim 13 wherein said media center receives and provides said digital content as streamed digital content to said digital content play system.

15. A system as claimed in claim 14 including terminal devices located in the public establishment and in communication with said digital content server, said terminal devices including software allowing users to select digital content for play on said digital content play system and said terminal devices communicating said selections to said digital content server, said digital content server thereafter providing said digital content to said media center as streamed digital content.

16. A system as claimed in claim 15 wherein said digital content server includes a queue management function for the system and provides streamed digital content to the media center based on the queue management function.

17. A system as claimed in claim 15 including a queue management system allowing a user to select a higher price option for earlier play of selected digital content.

18. A system as claimed in claim 17 including a fixed price for play of digital content added to the end of a queue of the queue management system.

19. A system as claimed in claim 18 including a variable price for the play of digital content to be added to the head of a queue of the queue management system.

20. A system as claimed in claim 14 wherein said media center includes a queue management function for establishing the order of play of digital content and instructs said digital content server with respect to the next digital content to be played.

21. A system as claimed in claim 11 including menus of listed digital content available for play in said commercial establishment with said menus being available in said commercial establishments.

22. A system as claimed in claim 21 wherein said menus are printed and made available to patrons of the public establishment.

23. A system as claimed in claim 22 wherein digital content can be ordered by using SMS text messaging or placing an order with an order staff assigned to patron by the commercial establishment.

24. A system as claimed in claim 22 wherein said menus include codes assigned to uniquely identify digital content for play.

25. A system as claimed in claim 24 wherein said codes include a location identification code identifying the commercial establishment or the media center of the commercial establishment.
